(19) United States
(12) Patent Application Publication
(10) Pub. No.: US 2008/0013172 A1
(43) Pub. Date: Jan. 17, 2008

(54) Method for Producing Light-Scattering Film, Polarizer Comprising Light-Scattering Film, and Liquid-Crystal Display Device Comprising Polarizer

(75) Inventors: Kazuhiro Nakamura, Kanagawa (JP); Rikio Inoue, Kanagawa (JP)

Correspondence Address: BUCHANAN, INGERSOLL & ROONEY PC, POST OFFICE BOX 1404, ALEXANDRIA, VA, 22313-1404, US

(73) Assignee: Fujifilm Corporation, Tokyo (JP)

(21) Appl. No.: 11/666,971

(22) PCT Filed: Nov. 1, 2005
(86) PCT No.: PCT/JP05/20398

§ 371 Date: May 1, 2007

(30) Foreign Application Priority Data
Nov. 4, 2004 (JP) 2004-320752

(51) Int. Cl. G02B 5/30; G02B 1/10

(52) U.S. Cl. 359/485; 427/161

(57) ABSTRACT

A method for producing a light-scattering film that comprises a light-scattering layer on a transparent support, comprising: 1) a step of preparing a coating composition for the light-scattering layer, which comprises: translucent particles; a translucent resin that comprises a translucent polymer having a molecular weight of 1000 or more in a ratio of 0.1% by mass or more of the coating composition; and a solvent, 2) a step of running the transparent support which is supported by a backup roll, 3) a step of jetting out the coating composition for the light-scattering layer through a tip of a slot die of an extrusion-type coating machine; and 4) a step of applying the coating composition for the light-scattering layer that has been jetted out through a slot of a tip lip of the slot die, onto the transparent support, while a land of the tip lip is kept adjacent to a surface of a web of the running transparent support.

### TECHNICAL FIELD

The present invention relates to a method for producing a light-scattering film, and more precisely to a method of producing a light-scattering film having the advantage of uniform in-plane light scatterability, which comprises applying a coating composition with precipitation-controlled translucent particles therein onto a support by the use of a die coater and which therefore realizes high producibility. The invention also relates to a polarizer that comprises the light-scattering film, and to a liquid-crystal display device that comprises the polarizer.

### BACKGROUND ART

A light-scattering film is divided into two groups; one is an antiglare film having a surface light-scatterability, and the other is an internal light-scattering film having a light-scatterability only inside it. In general, such an antireflection film is disposed on the outermost surface of image display devices such as CRT, plasma display panels (PDP), electroluminescent display devices (ELD) and liquid-crystal display devices (LCD), for preventing image reflection owing to external light reflection on the displays. With the recent tendency toward high-definition display devices in the art, a technique has been disclosed that relates to an antiglare film having both surface scatterability and internal scatterability for the purpose of reducing the brightness unevenness (this causes glaring) of an ordinary antiglare film (JP-A 2000-304648, Japanese Patent No. 3,507,719, Japanese Patent No. 3,515,401, Japanese Patent No. 3,515,426).

On the other hand, a technique has been disclosed, relating to a light-scattering film not having a surface light-scatterability but having an internal light-scatterability alone, and this is for improving the viewing angle characteristics of LCD (JP-A 2003-121606). As in JP-A 2003-121606 and JP-A 2003-270409, it is known that, when a light-scattering film is used as the outermost surface layer of a display device, then the film preferably has an additional antireflection function of preventing surface reflection of external light in a light room.

The light-scattering film as above has heretofore been produced according to a bar-coating method, a gravure-coating method or a microgravure-coating method. Recently, a technique relating to a die-coating method, as one type of an extrusion-coating method, has been disclosed in JP-A 2003-236434, which attains higher producibility and is favorably used in a region of a relatively small wet coating amount.

However, when the coating composition for a light-scattering layer disclosed JP-A 2003-236434 is applied onto a support according to a die-coating method, then there occurs a problem of in-plane unevenness of the light-scattering film produced because the translucent particles in the coating composition may stay in the pocket inside the die coater used or the density of the translucent particles in the composition that is jetted out in the cross direction of the slot may be uneven.

### DISCLOSURE OF THE INVENTION

In short as above, any method for producing a light-scattering film having a uniform in-plane light-scatterability according to a die-coating process that satisfies high producibility is not as yet proposed at present.

An object of the invention is to provide a method for producing a light-scattering film having a uniform in-plane light scatterability and a light-scattering film further having an additional antireflection function according to a die-coating process at high producibility.

Another object of the invention is to provide a polarizer that comprises the light-scattering film, and to provide a liquid-crystal display device comprising the polarizer.

### Means for Solving the Problems

We, the present inventors have assiduously studied for the purpose of attaining the above-mentioned objects and, as a result, have experimentally found that, when the redispersibility of the coating liquid for a light-scattering film, which is once statically left as such as then stirred for redispersing the precipitated particles therein, is better, then the in-plane film unevenness of the film formed can be more favorably prevented, and therefore have found that, when the viscosity of the coating liquid and the redispersibility of the translucent particles in the coating composition are controlled by adding a translucent polymer having a molecular weight of 1000 or more to the coating composition, then the above-mentioned objects can be attained. On the basis of these findings, we have completed the present invention.

Specifically, the invention has attained the above-mentioned objects, having the constitution mentioned below.

1. A method for producing a light-scattering film that comprises a light-scattering layer on a transparent support, comprising:

1) a step of preparing a coating composition for the light-scattering layer, which comprises: translucent particles; a translucent resin that comprises a translucent polymer having a molecular weight of 1000 or more in a ratio of 0.1% by mass or more of the coating composition; and a solvent,

2) a step of running the transparent support which is supported by a backup roll,

3) a step of jetting out the coating composition for the light-scattering layer through a tip of a slot die of an extrusion-type coating machine; and

4) a step of applying the coating composition for the light-scattering layer that has been jetted out through a slot of a tip lip of the slot die, onto the transparent support, while a land of the tip lip is kept adjacent to a surface of a web of the running transparent support.

2. The method for producing a light-scattering film of above 1, wherein the translucent polymer having a molecular weight of 1000 or more in the translucent resin in the coating composition is at least one selected from cellulose derivatives, poly(meth)acrylate derivatives, and poly(vinyl ester)-based polymers.

3. The method for producing a light-scattering film of above 1 or 2, wherein a viscosity of the coating composition at 25° C. is controlled to be from 1 to 15 mPa·s.

4. The method for producing a light-scattering film of any of above 1 to 3, wherein a mean particle size of the translucent fine particles is from 0.5 to 10 μm, a refractivity difference between the translucent fine particles and the translucent resin is from 0.02 to 0.2, and an amount of the translucent particles in the light-scattering layer is from 3 to 30% by mass of a total solid content of the light-scattering layer.

5. The method for producing a light-scattering film of any of above 1 to 4, wherein the translucent particles are crosslinked polystyrene particles, crosslinked poly(acryl-styrene) particles, crosslinked poly((meth)acrylate) particles or their mixture, the solvent is at least one selected from ketones, toluene, xylene and esters.

6. The method for producing a light-scattering film of any of above 1 to 5, wherein a low-refractivity layer having a lower refractive index than that of the support is formed on the light-scattering layer directly thereon or via any other layer therebetween, and the film has a function as an antireflection film.

7. The method for producing a light-scattering film of any of above 1 to 6, wherein the slot die used for the coating operation is an overbite-shaped slot die that has a land length of from 30 μm to 100 μm at the tip lip thereof on a web-running direction side and is so designed that, when the slot die is set at the coating position, then a distance between the tip lip and the web on the web-running direction side is smaller by from 30 μm to 120 μm than a distance between the tip lip and the web on the side opposite to the web-running direction side.

8. A polarizer comprising a polarizing film; and two protective films stuck to the polarizing film so as to protect both a front face and a back face of the polarizing film, wherein the light-scattering film produced according to the production method of any of claims 1 to 7 is used as a protective film on one side of the polarizing film.

9. The polarizer of above 8, wherein the other film than the light-scattering film of the two protective films has an optically-compensatory layer that comprises an optically-anisotropic layer, on the side opposite to the side on which it is stuck to the polarizing film, the optically-anisotropic layer is a layer comprising a compound having a discotic structure unit, a disc face of the discotic structure unit is inclined relative to a protective film face, and an angle between the disc face of the discotic structure unit and the protective film face varies in a depth direction of the optically-anisotropic layer.

10. A liquid-crystal display device comprising at least one polarizer of above 8 or 9.

### BRIEF DESCRIPTION OF THE DRAWINGS

FIG. 1 is a cross-sectional view graphically showing one preferred embodiment having a layer constitution of an antireflection film) of an antiglare light-scattering film of the invention;

FIG. 2 is a cross-sectional view of a coater 10 with a slot die 13, used in carrying out the invention;

FIG. 3A shows a cross section of a slot die 13 used in the invention;

FIG. 3B shows a cross section of an ordinary slot die 30;

FIG. 4 is a perspective view showing a slot die 13 and around it, used in the coating step in the invention;

FIG. 5 is a cross-sectional view showing a pressure reduction chamber 40 and a web W that are in adjacent to each other; and

FIG. 6 is a cross-sectional view showing a pressure reduction chamber 40 and a web W that are in adjacent to each other.

G_{L} denotes a gap between a tip lip 17 and a web W (gap between downstream a lip land 18b and a web W); G_{B} denotes a gap between a back plate 40a and a web W; G_{S} denotes a gap between a side plate 40b and a web W; I_{UP} denotes a land length of an upstream lip land 18a; I_{LO} denotes a land length of a downstream lip land 18b; LO denotes an0 overbite length (difference between the distance from a downstream lip land 18b to a web W and the distance from an upstream lip land 18a to a web W); W denotes a web; 1 denotes a light-scattering film (antireflection film); 2 denotes a transparent support; 3 denotes a light-scattering layer; 4 denotes a low-refractivity layer; 5 denotes translucent particles; 10 denotes a coater; 11 denotes a backup roll; 13 denotes a slot die; 14 denotes a coating liquid; 14a denotes a bead; 14b denotes a coating film; 15 denotes a pocket; 16 denotes a slot; 17 denotes a tip lip; 18 denotes a land; 18a denotes an upstream lip land; 18b denotes a downstream lip land; 30 denotes an ordinary slot die; 31a denotes an upstream lip land; 31b denotes a downstream lip land; 32 denotes a pocket; 33 denotes a slot; 40 denotes a pressure reduction chamber; 40a denotes a back plate; and 40b denotes a side plate; 40c denotes a screw

### BEST MODE FOR CARRYING OUT THE INVENTION

The invention is described in more detail hereinunder. In this description, when the numerical data indicate physical data or characteristic data, then the expression for them “from a number to another number” means the range that falls between the former number and the latter number both inclusive. Also in this description, the wording “(meth)acrylate” means “at least any of acrylate and methacrylate”. The same shall apply to “(meth)acrylic acid”.

The basic constitution of one preferred embodiment of the light-scattering film of the invention is described with reference to the drawings attached hereto.

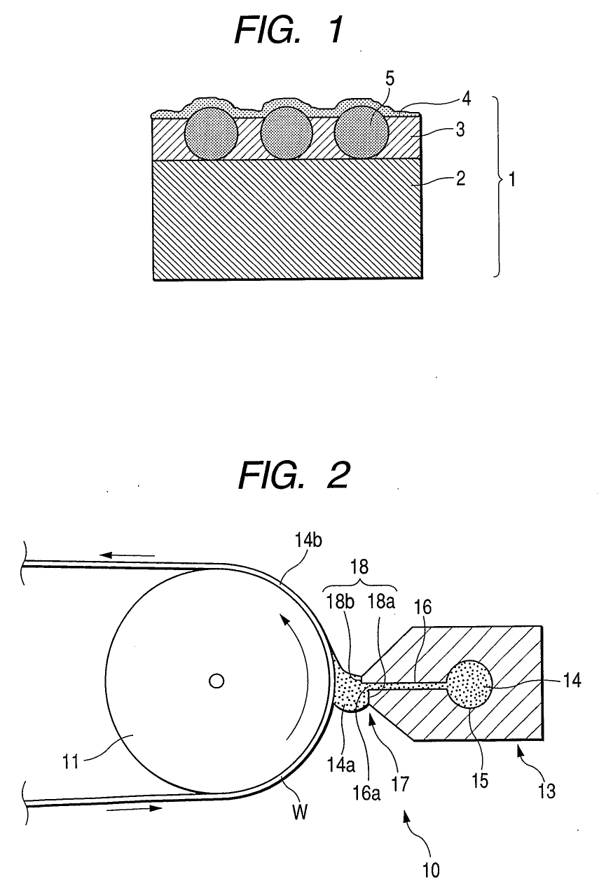

FIG. 1 is a schematic cross-sectional view graphically showing one preferred embodiment of an antiglare light-scattering film of the invention.

The light-scattering film 1 of this embodiment shown in FIG. 1 comprises a transparent support 2, a light-scattering layer 3 formed on the transparent support 2, and a low-refractivity layer 4 formed on the light-scattering layer 3. This embodiment is favorable since it has a low-refractivity layer having a thickness of around ¼ of the wavelength of light formed on the light-scattering layer thereof and its surface reflection may be reduced owing to the principle of thin film interference.

The light-scattering layer 3 comprises a translucent resin and translucent particles 5 dispersed in the translucent resin.

The refractive index of each layer that constitutes the light-scattering film having an antireflection layer of the invention preferably satisfies the following condition. Refractive index of light-scattering layer>refractive index of transparent support>refractive index of low-refractivity layer.

In the invention, the light-scattering layer may be an antiglare layer, or may be a layer substantially not having an antiglare property but having an internal light-scatterability alone, or may have both an antiglare property and an internal light-scatterability. The antiglare light-scattering layer preferably have both an antiglare property and a property of a hard coat layer. In FIG. 1 showing this embodiment, the light-scattering layer is a single layer. Apart from this, however, the layer may have a multi-layer structure, for example, comprising from 2 to 4 layers. The layer may be directly formed on a transparent support as in this embodiment, but it may be formed thereon via any other layer such as an antistatic layer or an moisture-proof layer therebetween.

Regarding its surface roughness profile, the antiglare light-scattering film of the invention is preferably so designed that it has a center line average height, Ra, of from 0.08 to 0.40 μm, a ten-point mean roughness, Rz, of at most 10 times that of Ra, a mean distance between the adjacent protrusion and valley, Sm, of from 1 to 100 μm, a standard deviation of the protrusion height from the deepest valley of at most 0.5 μm, a standard deviation of the mean protrusion-valley distance Sm, based on the center line, is at most 20 μm, and a proportion of the face having a tilt angle of from 0 to 5 degrees of at least 10%, in order that the film may have a satisfactory antiglare property and a visually uniform mat texture.

In this embodiment, it is desirable that the reflected light in a color space CIE1976L*a*b* under a C light source satisfies the condition that the a* value is from −2 to 2, the b* value is from −3 to 3 and the ratio of the minimum value to the maximum value of the refractivity within a range of from 380 nm to 780 nm falls between 0.5 and 0.99, since the color tone of the reflected light could be neutral in that condition. Also preferably, the b* value of the transmitted light under a C light source is from 0 to 3, since the yellow tone of white expression through the film could be reduced when the film is applied to display devices. When a lattice of 120 μm×40 μm is inserted between the planar light source and the antireflection film of the invention, it is desirable that the brightness distribution standard deviation measured on the film could be at most 20. This is because when the film of the invention of that type is applied to high-definition panels, then it effectively reduces glaring on the panels.

On the other hand, regarding the surface roughness profile of the light-scattering film of the invention having an internal light-scatterability alone, it is desirable that the center line average height, Ra, of the film is at most 0.10 μm, and the film does not substantially have an antiglare property. The light-scattering layer of the film has a large number of regions having a different refractive index inside it, and therefore the film has an internal light-scatterability. Preferably, the light-scattering characteristics of the film of the type are so optimized that, when the film is applied to the outermost surface of liquid-crystal display devices, then it may be effective for improving the viewing angle characteristics of the devices.

Regarding the optical characteristics of the light-scattering film having an antireflection layer of the invention, it is desirable that the film has a mirror reflectivity of at most 2.5% and a transmittance of at least 90% in order that it can prevent external light reflection thereon and can exhibit good visibility. Also preferably, the film satisfies the following: it has a haze of from 20% to 60% and has a ratio of internal haze/overall haze of from 0.3 to 1, the reduction in the haze of the film from after the formation of the light-scattering layer therein to after the formation of a low-refractivity layer thereon is at most 15%, the transmitted light sharpness through a comb width of 0.5 mm of the film is from 10% to 70%, and the transmittance ratio of vertically-transmitted light/transmitted light in the direction inclined by 2 degrees from the vertical direction of the film is from 1.5 to 5.0. This is because the film of the type is effective for preventing the glare on high-definition LCD panels and for preventing letters and others from being blurred thereon.

The light-scattering layer of the film of the invention is described below.

<Light-Scattering Layer>

The light-scattering layer is formed for the purpose of imparting a light-diffusive property owing to at least any of surface light scattering or internal light scattering, to the film, and preferably for the purpose of imparting thereto a hard coat property of improving the scratch resistance of the film. Accordingly, the light-scattering layer contains a translucent resin (preferably for imparting the hard coat property to the film), translucent particles for imparting the light-scattering property thereto and a solvent, as indispensable components thereof. Further, a translucent polymer having a molecular weight of at least 1000 is added to the coating liquid for the layer, in an amount of at least 0.1% by mass of the liquid. This is a translucent resin component of the layer, and improves the redispersibility of the translucent particles in the coating liquid. Accordingly, the coating liquid may be applied to a transparent support to form thereon a high in-plane uniformity layer according to a die-coating process at high producibility. The translucent polymer having a molecular weight of at least 1000 may penetrate into the space between the translucent particles when the particles have precipitated in the coating liquid, and, as a result, the particle-to-particle distance can be kept broad, thereby bringing about the following advantages: (1) A precipitated solid having a high density, in which the particle-to-particle distance is extremely small and the particles have a strong interaction, is prevented from being formed; and (2) when redispersed during stirring or feeding, the particles may rapidly take a solvent into them and the viscosity of the precipitated matter may be reduced, and the redispersibility of the coating liquid could be thereby improved.

In addition, since the redispersibility thereof is thus improved, another advantage of the coating liquid is as follows: Even in a case of a die-coating process where the amount of the coating liquid to be fed to the coating system is small and where the translucent particles are being precipitated in the liquid, the translucent particles may hardly remain in the pocket inside the die coater owing to the stirring effect of the liquid being fed out of the tank of the coater, and, as a result, the density of the translucent particles in the coating liquid that is jetted out in the cross direction of the slot of the die coater could be uniform.

The factors to control the precipitation speed of the translucent particles include the specific gravity difference between the coating composition and the translucent particles therein, the viscosity of the coating composition and the particle size of the translucent particles, as in the following formula (1). However, the redispersibility of the precipitated translucent particles in the invention does not always have a correlation with the precipitation speed represented by the following formula (1), and even though its precipitation speed is low, there may be a coating composition having a good redispersibility.

Preferably, the viscosity at 25° C. of the coating composition for a light-scattering layer is controlled to be from 1 to 15 mPa·s, whereby the coating speed of the composition in a die-coating process may be kept high.
Precipitation Speed Vs=( 1/18)×(σ−ρ)×(g/μ)×d², Formula (1)
wherein a indicates the density (g/cm³) of the translucent particles, ρ indicates the density (g/cm³) of the coating composition; g indicates the gravitational acceleration, d indicates the mean particle size (μm) of the translucent particles, and μ indicates the viscosity (Pa·s) of the coating composition.

In the coating composition for forming the light-scattering film of the invention, when the translucent particles have been swollen in some degree by the solvent therein, then the bulk density of the precipitated translucent particles increases and therefore the particles may have a large quantity of the solvent between them. This is favorable since the redispersibility of the precipitated particles increases. Preferred combinations of the translucent particles and the solvent for them are mentioned. The translucent particles are preferably crosslinked polystyrene particles, crosslinked poly(acryl-styrene) particles, crosslinked poly((meth)acrylate) particles or their mixture; and the solvent is preferably at least one selected from ketones, toluene, xylene and esters. The swelling of the translucent particles may be controlled by the crosslinked density of the particles, and therefore may be controlled by the combination of the particles with the solvent used for them.

<Translucent Particles>

The mean particle size of the translucent fine particles is preferably 0.5 to 10 μm, particularly preferably 1.0 to 5.0 μm.

The mean particle size of the translucent particles is preferably from 0.5 to 5 μm, more preferably from 1.0 to 4.0 μm. If the mean particle size is smaller than 0.5 μm, then the light scattering angle distribution may broaden to a broad angle, and it is unfavorable since the letter resolution of displays may be thereby lowered. On the other hand, if the mean particle size is larger than 5 μm, then the absolute value of the above formula (1) may increase too much and therefore the precipitation speed of the particles may be high. If so, there occur various problem in that the thickness of the light-scattering layer for the film must be large, the film may curl greatly, and the material cost may increase.

Specific examples of the translucent particles are inorganic compound particles such as silica particles, TiO₂ particles; and resin particles such as poly((meth)acrylate) particles, crosslinked poly((meth)acrylate) particles, polystyrene particles, crosslinked polystyrene particles, crosslinked poly(acryl-styrene) particles, melamine resin particles, benzoguanamine resin particles. Of those, preferred are crosslinked polystyrene particles, crosslinked poly((meth)acrylate) particles, crosslinked poly(acryl-styrene) particles, and their mixtures.

Regarding their shape, the translucent particles are preferably spherical. They may be amorphous, but amorphous translucent particles must be pretreated before use since their light-scattering characteristics in a light-scattering film differ from those of spherical translucent particles therein.

Two or more different types of translucent particles having a different particle size may be used herein as combined. Translucent particles having a larger particle size may impart an antiglare property to the light-scattering film, while those having a smaller particle size may impart different optical properties to it. For example, when an antireflection film is stuck to a high-definition display of 133 ppi or more, then the display is required to have no optical problem of, for example, glaring such as that mentioned hereinabove. Glaring is caused by pixel expansion or reduction owing to the surface roughness of the film (the surface roughness may contribute to the antiglare property of the film) to lose the brightness uniformity of the film. When translucent particles having a smaller particle size than those acting to impart an antiglare property to the film and having a different refractivity from that of the binder in the film are used as combined with large-size translucent particles, then the antiglare property of the film may be significantly improved.

The translucent particles may be incorporated into the light-scattering layer preferably in an amount of from 3 to 30% by mass, more preferably from 5 to 20% by mass of the total solid content of the light-scattering layer, in view of the light-scattering effect, the image resolution, and the absence of surface whitening and surface glaring of the layer.

Preferably, the density of the translucent particles is from 10 to 1000 mg/m³, more preferably from 100 to 700 mg/m³.

The particle size distribution of the translucent particles may be determined according to a Coulter counter method, and the thus-determined distribution is converted into a particle number distribution.

The refractive index of the bulk of the mixture of the translucent resin and the translucent particles in the invention is preferably from 1.48 to 2.00, more preferably from 1.50 to 1.80. For controlling the refractivity to fall within the range as above, the type of the translucent resin and the translucent particles and the blend ratio of the two may be suitably determined and selected. The selection and the determination could be readily done through previous experiments.

In the invention, the refractivity difference between the translucent resin and the translucent particles (the refractive index of the translucent particles—the refractive index of the translucent resin) is preferably from 0.02 to 0.2, more preferably from 0.05 to 0.15. When the difference falls within the range, then the internal scattering effect of the film is sufficient, and the film does not glare and the film surface does not become cloudy.

Preferably, the refractive index of the translucent resin is from 1.45 to 2.00, more preferably from 1.48 to 1.60.

Also preferably, the refractive index of the translucent particles is from 1.40 to 1.80, more preferably from 1.50 to 1.70.

The refractive index of the translucent resin may be directly measured by the use of an Abbe's refractometer, or may be quantitatively determined through reflection spectrometry or spectral ellipsometry.

The thickness of the light-scattering layer is preferably from 1 to 30 μm, particularly preferably from 1 to 10 μm. When the thickness falls within the above-cited range, then the layer may have a hard coat property, its curling behavior as well as brittleness improves, and thus its workability is excellent.

<Translucent Resin>

The translucent resin is preferably a binder polymer having a saturated hydrocarbon chain or a polyether chain as the backbone structure thereof, more preferably a binder polymer having a saturated hydrocarbon chain as the backbone structure thereof. Also preferably, the binder polymer has a crosslinked structure.

The binder polymer having a saturated hydrocarbon chain as the backbone structure preferably comprises a polymer of an ethylenic unsaturated monomer as the principal ingredient thereof. The binder polymer having a saturated hydrocarbon chain as the backbone structure and having a crosslinked structure is preferably a (co)polymer of a monomer having two or more ethylenic unsaturated groups.

In the method of forming the light-scattering layer in the invention, the coating composition for the layer indispensably contains a translucent polymer having a molecular weight of 1000 or more in the translucent resin therein, in an amount of 0.1% by mass or more, preferably from 0.1 to 20% by mass, more preferably from 0.2 to 10% by mass, even more preferably from 0.3 to 5% by mass of the coating composition (coating liquid), for the purpose of controlling the viscosity of the coating composition and for improving the redispersibility of the precipitated translucent particles in the composition.

The monomer having two or more ethylenic unsaturated groups includes esters of polyalcohols and (meth)acrylic acids (e.g., ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol (meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate); ethylene oxide-modified derivatives of the above-mentioned esters; vinylbenzene and its derivatives (e.g., 1,4-divinylbenzene, 2-acryloylethyl 4-vinylbenzoate, 1,4-divinylcyclohexanone); vinyl sulfones (e.g., divinyl sulfone); acrylamides (e.g., methylenebisacrylamide); and methacrylamides. Two or more of these monomers may be used as combined.

The translucent polymer having a molecular weight of at least 1000 is preferably at least one selected from cellulose derivatives and poly(meth)acrylate derivatives, from the viewpoint of (1) improvement in the redispersibility of translucent particles, (2) sufficient compatibility of the polymer with the above-mentioned monomer and (3) solubility of the polymer in the coating solvent mentioned below. Concretely, the cellulose derivatives are cellulose acetate butyrate, cellulose acetate propionate, cellulose diacetate, cellulose propionate; and the poly(meth)acrylate derivatives are polymethyl (meth)acrylate, polybutyl (meth)acrylate, and their copolymers, as well as copolymers of at least one of these monomers and a comonomer such as hydroxyethyl (meth)acrylate or hydroxybutyl (meth)acrylate. If desired, two or more of these may be used, as combined.

As the translucent polymer having a molecular weight of at least 1000, poly(vinyl ester)-based polymers are preferred in addition to the above-cited ones. In the poly(vinyl esters) are included the homopolymer of a vinyl ester, copolymers of two or more vinyl esters and copolymers of a vinyl ester with another monomer having ethylenically unsaturated double bond. Vinyl esters such as, for example, vinyl formate, vinyl acetate, vinyl propionate, vinyl versatate and vinyl stearate are mentioned. As specific examples of the poly(vinyl ester)-based polymer, poly(vinyl acetate) and poly(vinyl propionate) are preferred in particular.

With respect to the translucent polymer having a molecular weight of at least 1000, the molecular weight means weight average one. And a molecular weight of from 1000 to 2000000 is preferred, that of from 10000 to 2000000 is more preferred, and that of from 50000 to 1000000 is particularly preferred.

The molecular weight and weight average molecular weight referred to herein are those measured with use of a GPC analyzer and expressed in terms of the polystyrene-converted value detected by differential refractometry using THF as the solvent.

Polymerization of the ethylenic unsaturated group-having monomers may be effected through exposure to ionizing radiations or to heat in the presence of an optical radical initiator or a thermal radical initiator.

Accordingly, the light-scattering layer mentioned above may be formed as follows: A coating liquid that comprises a monomer for formation of a translucent resin such as the above-mentioned ethylenic unsaturated monomer, an optical radical initiator or a thermal radical initiator, translucent particles, and optionally an inorganic filler mentioned below is prepared, and the coating liquid is applied onto a transparent support, and then polymerized and cured through exposure to ionizing radiations or to heat to form the intended layer on the support.

The optical radical (polymerization) initiator includes acetophenones, benzoins, benzophenones, phosphine oxides, ketals, anthraquinones, thioxanthones, azo compounds, peroxides, 2,3-dialkyldione compounds, disulfide compounds, fluoroamine compounds, and aromatic sulfoniums. Examples of acetophenones are 2,2-diethoxyacetophenone, p-dimethylacetophenone, 1-hydroxydimethylphenyl ketone, 1-hydroxycyclohexylphenyl ketone, 2-methyl-4-methylthio-2-morpholinopropiophenone, and 2-benzyl-2-dimethylamino-1-(4-morpholinophenyl)butanone. Examples of benzoins are benzoin benzenesulfonates, benzoin toluenesulfonates, benzoin methyl ether, benzoin ethyl ether, and benzoin isopropyl ether. Examples of benzophenones are benzophenone, 2,4-dichlorobenzophenone, 4,4-dichlorobenzophenone, and p-chlorobenzophenone. One example of phosphine oxides is 2,4,6-trimethylbenzoyldiphenylphosphine oxide.

Various examples of the compounds are described in the Newest UV Curing Technology (p. 159, issued by Kazuhiro Takatsu, published by Gijutsu Joho Kyokai, 1991), and these are useful in the invention.

Preferred examples of commercially-available, photo-cleaving optical radical (polymerization) initiators are Ciba Speciality Chemicals' Irgacure (651, 184, 907).

Preferably, the optical radical (polymerization) initiator is used in an amount of from 0.1 to 15 parts by mass relative to 100 parts by mass of the polyfunctional monomer, more preferably from 1 to 10 parts by mass.

An optical sensitizer may be added to the optical radical (polymerization) initiator. Examples of the optical sensitizer are n-butylamine, triethylamine, tri-n-butyl phosphine, Michler's ketone, and thioxanthone.

The thermal radical initiator includes organic or inorganic peroxides, and organic azo and diazo compounds.

Concretely, the organic peroxides include benzoyl peroxide, halogenobenzoyl peroxide, lauroyl peroxide, acetyl peroxide, dibutyl peroxide, cumene hydroperoxide, butyl hydroperoxide; the inorganic peroxides include hydrogen peroxide, ammonium persulfate, potassium persulfate; the azo compounds include 2-azobisisobutyronitrile, 2-azobispropionitrile, 2-azobiscyclohexane-dinitrile; and the diazo compounds include diazoaminobenzene, and p-nitrobenzene-diazonium.

The polymer having a polyether backbone structure is preferably a ring-cleaved polymer of a polyfunctional epoxy compound. Ring-cleavage polymerization of a polyfunctional epoxy compound may be effected through exposure to ionizing radiations or to heat in the presence of an optical acid generator or a thermal acid generator.

Accordingly, a coating liquid comprising a polyfunctional epoxy compound, an optical acid generator or a thermal acid generator and an inorganic filler is prepared, and the coating liquid is applied onto a transparent support, and then polymerized and cured through exposure to ionizing radiations or to heat to form a light-scattering layer thereon.

In place of or in addition to the monomer that has two or more ethylenic unsaturated groups, a monomer that has a crosslinking functional group may be used so as to introduce the crosslinking functional group into the polymer, and through the reaction of the crosslinking functional group, a crosslinked structure may be introduced into the binder polymer.

Examples of the crosslinking functional group are an isocyanate group, an epoxy group, an aziridine group, an oxazoline group, an aldehyde group, a carbonyl group, a hydrazine group, a carboxyl group, a methylol group, and an active methylene group. Vinylsulfonic acids, acid anhydrides, cyanoacrylate derivatives, melamines, etherified methylols, esters and urethanes, and metal alkoxides such as tetramethoxysilane may also be used as monomers for introducing a crosslinked structure into the polymer. A functional group that may be crosslinkable as a result of decomposition reaction, such as a blocked isocyanate group may also be used. Accordingly, in the invention, the crosslinking functional group may not be one that is directly reactive, but may be one that becomes reactive as a result of decomposition.

The binder polymer having such a crosslinking functional group may be, after applied onto a support, heated to form the intended crosslinked structure.

In addition to the above-mentioned translucent particles, the light-scattering layer may contain an inorganic filler for further increasing the refractivity of the layer. The inorganic filler comprises an oxide of at least one metal selected from titanium, zirconium, aluminium, indium, zinc, tin and antimony, and has a mean particle size of at most 0.2 μm, preferably at most 0.1 μm, more preferably at most 0.06 μm.

On the contrary, for the purpose of increasing the refractivity difference from the translucent particles, a silicon oxide may be sued in the light-scattering layer comprising high-refractivity translucent particles. This is for lowering the refractivity of the layer. The preferred particle size of the oxide may be the same as that of the above-mentioned inorganic filler. The inorganic filler generally has a higher specific gravity than that of an organic substance, and is therefore effective for increasing the density of the coating composition. As a result, this is effective for lowering the precipitation speed of the translucent particles in the composition.

Preferably, the inorganic filler for use in the light-scattering layer undergoes silane coupling treatment or titanium coupling treatment, for which preferably used is a surface-treating agent that may give a functional group capable of reacting with a binder, to the filler surface.

The amount of the inorganic filler of the type that may be added to the light-scattering layer is preferably from 10 to 90%, more preferably from 20 to 80%, even more preferably from 30 to 75% of the total mass of the layer.

Since the particle size of the inorganic filler of the type is sufficiently smaller than the wavelength of light, the filler does not cause light scattering therearound, and the dispersion formed by dispersing the filler in a binder polymer behaves as an optically uniform substance as a whole.

The light-scattering layer may contain an organosilane compound. The amount of the organosilane compound that may be added to the layer is preferably from 0.001 to 50% by mass of the total solid content of the layer (to which the compound is added), more preferably from 0.01 to 20% by mass, even more preferably from 0.05 to 10% by mass, still more preferably from 0.1 to 5% by mass.

<Surfactant for Light-Scattering Layer>

The coating composition for the light-scattering layer in the invention contains a fluorine-containing surfactant or a silicone-type surfactant or both the two, in order that the light-scattering layer formed may have good surface uniformity, not having coating troubles such as coating unevenness, drying unevenness and spot defects. In particular, a fluorine-containing surfactant is preferred since it is more effective for preventing the surface defects of the antireflection film of the invention, such as the coating unevenness, the drying unevenness and the spot defects thereof, even when its amount added to the layer is small.

The surfactant is for improving the surface uniformity of the layer formed and for improving the rapid coatability of the coating composition to thereby increase the producibility of the layer-coated film.

One preferred example of the fluorine-containing surfactant is a fluoro-aliphatic group-containing copolymer (this may be hereinafter abbreviated to “fluoropolymer”). Useful examples of the fluoropolymer are acrylic resins and methacrylic resins that contain repetitive units corresponding to the following monomer (i) or repetitive units corresponding to the following monomer (ii), and their copolymers with vinyl monomers copolymerizable with them.
(i) Fluoro-Aliphatic Group-Containing Monomer of the Following Formula (a):

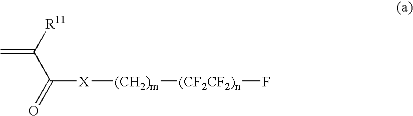

In formula (a), R¹¹ represents a hydrogen atom or a methyl group; X represents an oxygen atom, a sulfur atom, or —N(R¹²)—; m indicates an integer of from 1 to 6; n indicates an integer of from 2 to 4. R¹² represents a hydrogen atom, or an alkyl group having from 1 to 4 carbon atoms, concretely a methyl group, an ethyl group, a propyl group or a butyl group, preferably a hydrogen atom or a methyl group. X is preferably an oxygen atom.
(ii) Monomer of the Following Formula (B) that is Copolymerizable with the Above (i):

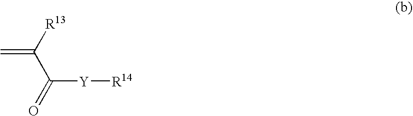

In formula (b), R¹³ represents a hydrogen atom or a methyl group, Y represents an oxygen atom, a sulfur atom, or —N(R¹⁵)—. R¹⁵ represents a hydrogen atom, or an alkyl group having from 1 to 4 carbon atoms, concretely a methyl group, an ethyl group, a propyl group or a butyl group, preferably a hydrogen atom or a methyl group. Y is preferably an oxygen atom, —N(H)— or —N(CH₃)—.

R¹⁴ represents an optionally-substituted, linear, branched or cyclic alkyl group having from 4 to 20 carbon atoms. The substituent for the alkyl group for R¹⁴ includes a hydroxyl group, an alkylcarbonyl group, an arylcarbonyl group, a carboxyl group, an alkylether group, an arylether group, a halogen atom such as fluorine, chlorine or bromine, a nitro group, a cyano group and an amino group, to which, however, the substituent is not limited. Preferred examples of the linear, branched or cyclic alkyl group having from 4 to 20 carbon atoms are linear or branched butyl, pentyl, hexyl, heptyl, octyl, nonyl, decyl, undecyl, dodecyl, tridecyl, tetradecyl, pentadecyl, octadecyl and eicosyl groups; a monocyclic cycloalkyl group such as cyclohexyl and cycloheptyl groups; and a polycyclic cycloalkyl group such as bicycloheptyl, bicyclodecyl, tricycloundecyl, tetracyclododecyl, adamantyl, norbornyl and tetracyclodecyl groups.

The amount of the fluoro-aliphatic group-containing monomer of formula (a) that is to be in the fluoropolymer for use in the invention is at least 10 mmol %, preferably from 15 to 70 mol %, more preferably from 20 to 60 mol % of all the constitutive monomers of the fluoropolymer.

Preferably, the mass-average molecular weight of the fluoropolymer for use in the invention is from 3,000 to 100,000, more preferably from 5,000 to 80,000.

The preferred amount of the fluoropolymer for use in the invention is from 0.001 to 5% by mass, more preferably from 0.005 to 3% by mass, even more preferably from 0.01 to 1% by mass of the coating liquid. Falling within the range, the fluoropolymer is sufficiently effective, and the coating layer can be dried with no trouble, and, in addition, the coating layer may have good properties (e.g., reflectivity, scratch resistance).

Examples of the specific structure of the fluoropolymer that comprises the fluoro-aliphatic group-containing monomer of formula (a) are mentioned below, to which, however, the invention is not limited. The numeral written for each formula indicates the molar fraction of the monomer component. Mw means the mass-average molecular weight of the polymer.

| | | |
|---|---|---|
| 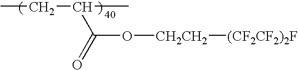 | 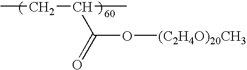 | FP-1 Mw 15,000 |
| 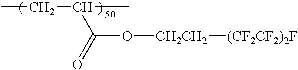 | 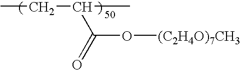 | FP-2 Mw 15,000 |
| 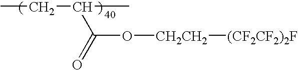 | 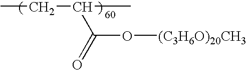 | FP-3 Mw 30,000 |
| 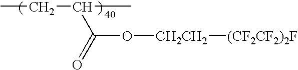 | 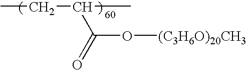 | FP-4 Mw 50,000 |
| 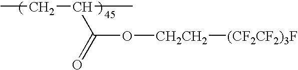 | 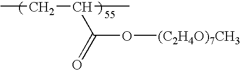 | FP-5 Mw 15,000 |
| 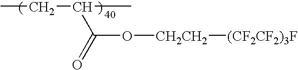 | 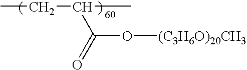 | FP-6 Mw 7,000 |
| 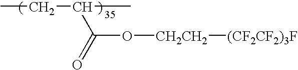 | 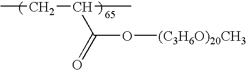 | FP-7 Mw 20,000 |
| 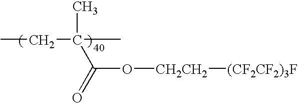 | 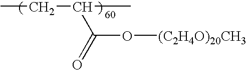 | FP-8 Mw 15,000 |
| 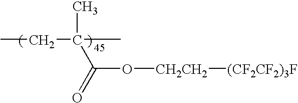 | 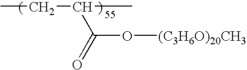 | FP-9 Mw 40,000 |
| 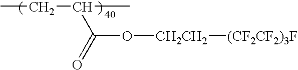 | 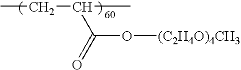 | FP-10 Mw 15,000 |
| 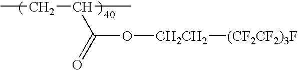 | 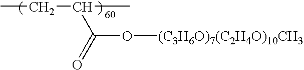 | FP-11 Mw 20,000 |
| 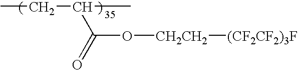 | 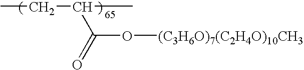 | FP-12 Mw 25,000 |

However, when the above-mentioned fluoropolymer is used in the light-scattering layer, then the surface energy of the light-scattering layer may lower owing to the segregation of the F atom-containing functional group in the surface of the layer, and, as a result, when a low-refractivity layer is overcoated on the light-scattering layer, there may occur a problem in that the antireflection capability of the film may be thereby worsened. This will be because the wettability of the curable composition to form the low-refractivity layer may be worsened and, as a result, the low-refractivity layer formed may have fine surface unevenness that could not be visually detected and its surface uniformity may be thereby worsened. For solving the problem, we the inventors have found that it is effective to control the surface energy of the light-scattering layer so as to fall preferably between 20 mN·m⁻¹ and 50 mN·m⁻¹, more preferably between 30 mN·m⁻¹ and 40 mN·m⁻¹, by specifically controlling the structure of the fluoropolymer to be used in the layer and the amount thereof. To realize the surface energy level as above, it is necessary that the ratio of the fluorine atom-derived peak to the carbon atom-derived peak, F/C, determined through X-ray photoelectron spectrometry falls between 0.1 and 1.5.

Apart from the above, a different method may be employed. Concretely, when the upper layer is formed, a fluoropolymer capable of being extracted out in a solvent in forming the upper layer is selected so as to prevent the polymer from being segregated in the surface of the lower layer (=interface), and the adhesiveness between the upper layer and the lower layer is ensured. As a result, even in a mode of high-speed coating, the antireflection film formed can still has planar surface uniformity and has good scratch resistance. According to still another method of preventing the reduction in surface free energy, the surface energy of the light-scattering layer before the formation of the low-refractivity layer thereon may be controlled to fall within the range as above, and the intended object may also be attained. Examples of the material are acrylic resins and methacrylic resins that contain repetitive units corresponding to a fluoro-aliphatic group-containing monomer of the following formula (c), and their copolymers with vinyl monomers copolymerizable with them.
(iii) Fluoro-Aliphatic Group-Containing Monomer of the Following Formula (c):

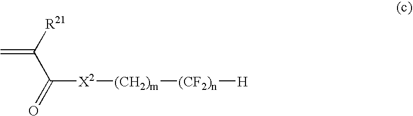

In formula (c), R²¹ represents a hydrogen atom, a halogen atom, or a methyl group, and is preferably a hydrogen atom or a methyl group. X² represents an oxygen atom, a sulfur atom, or —N(R²²)—, and is preferably an oxygen atom or —N(R²²)—, more preferably an oxygen atom. m indicates an integer of from 1 to 6, preferably from 1 to 3, more preferably 1. n indicates an integer of from 1 to 18, preferably from 4 to 12, more preferably from 6 to 8. R²² represents a hydrogen atom, or an optionally-substituted alkyl group having from 1 to 8 carbon atoms, and is preferably a hydrogen atom or an alkyl group having from 1 to 4 carbon atoms, more preferably a hydrogen atom or a methyl group. X² is preferably an oxygen atom.

The fluoropolymer may contain two or more different types of the fluoro-aliphatic group-containing monomer of formula (c) as the constitutive components thereof.
(iv) Monomer of the Following Formula (D) that is Copolymerizable with the Above (iii):

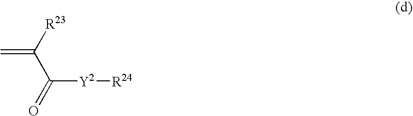

In formula (d), R²³ represents a hydrogen atom, a halogen atom or a methyl group, and is preferably a hydrogen atom or a methyl group. Y² represents an oxygen atom, a sulfur atom, or —N(R²⁵)—, and is preferably an oxygen atom or —N(R²⁵)—, more preferably an oxygen atom. R²⁵ represents a hydrogen atom, or an alkyl group having from 1 to 8 carbon atoms, and is preferably a hydrogen atom or an alkyl group having from 1 to 4 carbon atoms, more preferably a hydrogen atom or a methyl group.

R²⁴ represents an optionally-substituted, linear, branched or cyclic alkyl group having from 1 to 20 carbon atoms, a poly(alkyleneoxy) group-containing alkyl group, or an optionally-substituted aromatic group (e.g., phenyl group or naphthyl group). Preferably, it is a linear, branched or cyclic alkyl group having from 1 to 12 carbon atoms, or an aromatic group having from 6 to 18 carbon atoms in total, more preferably a linear, branched or cyclic alkyl group having from 1 to 8 carbon atoms.

Examples of the specific structure of the fluoropolymer that comprises repetitive units corresponding to the fluoro-aliphatic group-containing monomer of formula (c) are mentioned below, to which, however, the invention is not limited. The numeral written for each formula indicates the molar fraction of the monomer component. Mw means the mass-average molecular weight of the polymer.

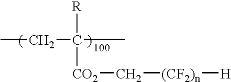

| | R | n | Mw |
|---|---|---|---|
| P-1 | H | 4 | 8000 |
| P-2 | H | 4 | 16000 |
| P-3 | H | 4 | 33000 |
| P-4 | CH₃ | 4 | 12000 |
| P-5 | CH₃ | 4 | 28000 |
| P-6 | H | 6 | 8000 |
| P-7 | H | 6 | 14000 |
| P-8 | H | 6 | 29000 |
| P-9 | CH₃ | 6 | 10000 |
| P-10 | CH₃ | 6 | 21000 |
| P-11 | H | 8 | 4000 |
| P-12 | H | 8 | 16000 |
| P-13 | H | 8 | 31000 |
| P-14 | CH₃ | 8 | 3000 |

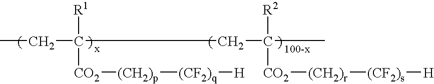

| | x | R¹ | p | q | R² | r | s | Mw |
|---|---|---|---|---|---|---|---|---|
| P-15 | 50 | H | 1 | 4 | CH₃ | 1 | 4 | 10000 |
| P-16 | 40 | H | 1 | 4 | H | 1 | 6 | 14000 |
| P-17 | 60 | H | 1 | 4 | CH₃ | 1 | 6 | 21000 |
| P-18 | 10 | H | 1 | 4 | H | 1 | 8 | 11000 |
| P-19 | 40 | H | 1 | 4 | H | 1 | 8 | 16000 |
| P-20 | 20 | H | 1 | 4 | CH₃ | 1 | 8 | 8000 |
| P-21 | 10 | CH₃ | 1 | 4 | CH₃ | 1 | 8 | 7000 |
| P-22 | 50 | H | 1 | 6 | CH₃ | 1 | 6 | 12000 |
| P-23 | 50 | H | 1 | 6 | CH₃ | 1 | 6 | 22000 |
| P-24 | 30 | H | 1 | 6 | CH₃ | 1 | 6 | 5000 |

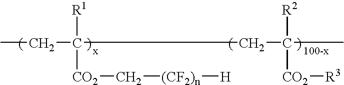

| | x | R¹ | n | R² | R³ | Mw |
|---|---|---|---|---|---|---|
| FP-148 | 80 | H | 4 | CH₃ | CH₃ | 11000 |
| FP-149 | 90 | H | 4 | H | C₄H₉(n) | 7000 |
| FP-150 | 95 | H | 4 | H | C₆H₁₃(n) | 5000 |
| FP-151 | 90 | CH₃ | 4 | H | CH₂CH(C₂H₅)C₄H₉(n) | 15000 |
| FP-152 | 70 | H | 6 | CH₃ | C₂H₅ | 18000 |
| FP-153 | 90 | H | 6 | CH₃ | 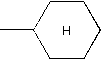 | 12000 |
| FP-154 | 80 | H | 6 | H | C₄H₉(sec) | 9000 |
| FP-155 | 90 | H | 6 | H | C₁₂H₂₅(n) | 21000 |
| FP-156 | 60 | CH₃ | 6 | H | CH₃ | 15000 |
| FP-157 | 60 | H | 8 | H | CH₃ | 10000 |
| FP-158 | 70 | H | 8 | H | C₂H₅ | 24000 |
| FP-159 | 70 | H | 8 | H | C₄H₉(n) | 5000 |
| FP-160 | 50 | H | 8 | H | C₄H₉(n) | 16000 |
| FP-161 | 80 | H | 8 | CH₃ | C₄H₉(iso) | 13000 |
| FP-162 | 80 | H | 8 | CH₃ | C₄H₉(t) | 9000 |
| FP-163 | 60 | H | 8 | H | 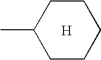 | 7000 |
| FP-164 | 80 | H | 8 | H | CH₂CH(C₂H₅)C₄H₉(n) | 8000 |
| FP-165 | 90 | H | 8 | H | C₁₂H₂₅(n) | 6000 |
| FP-166 | 80 | CH₃ | 8 | CH₃ | C₄H₉ (sec) | 18000 |
| FP-167 | 70 | CH₃ | 8 | CH₃ | CH₃ | 22000 |
| FP-168 | 70 | H | 10 | CH₃ | H | 17000 |
| FP-169 | 90 | H | 10 | H | H | 9000 |
| FP-170 | 95 | H | 4 | CH₃ | —(CH₂CH₂O)₂—H | 18000 |
| FP-171 | 80 | H | 4 | H | —(CH₂CH₂O)₂—CH₃ | 16000 |
| FP-172 | 80 | H | 4 | H | —(C₃H₆O)₇—H | 24000 |
| FP-173 | 70 | CH₃ | 4 | H | —(C₃H₆O)₁₃—H | 18000 |
| FP-174 | 90 | H | 6 | H | —(CH₂CH₂O)₂—H | 21000 |
| FP-175 | 90 | H | 6 | CH₃ | —(CH₂CH₂O)₈—H | 9000 |
| FP-176 | 80 | H | 6 | H | —(CH₂CH₂O)₂—(C₄H₉(n) | 12000 |
| FP-177 | 80 | H | 6 | H | —(C₃H₅O)₇—H | 34000 |
| FP-178 | 75 | F | 6 | H | —(C₃H₆O)₁₃—H | 11000 |
| FP-179 | 85 | CH₃ | 6 | CH₃ | —(C₃H₆O)₂₀—H | 18000 |
| FP-180 | 95 | CH₃ | 6 | CH₃ | —CH₂CH₂OH | 27000 |
| FP-181 | 80 | H | 8 | CH₃ | —(CH₂CH₂O)₈—H | 12000 |
| FP-182 | 95 | H | 8 | H | —(CH₂CH₂O)₉—CH₃ | 20000 |
| FP-183 | 90 | H | 8 | H | —(C₃H₆O)₇—H | 8000 |
| FP-184 | 95 | H | 8 | H | —(C₃H₆O)₂₀—H | 15000 |
| FP-185 | 90 | F | 8 | H | —(C₃H₆O)₁₃—H | 12000 |
| FP-186 | 80 | H | 8 | CH₃ | —(CH₂CH₂O)₂—H | 20000 |
| FP-187 | 95 | CH₃ | 8 | H | —(CH₂CH₂O)₉—CH₃ | 17000 |
| FP-188 | 90 | CH₃ | 8 | H | —(C₃H₆O)₇—H | 34000 |
| FP-189 | 80 | H | 10 | H | —(CH₂CH₂O)₃—H | 19000 |
| FP-190 | 90 | H | 10 | H | —(C₃H₆O)₇—H | 8000 |
| FP-191 | 80 | H | 12 | H | —(CH₂CH₂O)₇—CH₃ | 7000 |
| FP-192 | 95 | CH₃ | 12 | H | —(C₃H₆O)₇—H | 10000 |

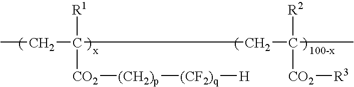

| | x | R¹ | p q | R² | R³ | Mw |
|---|---|---|---|---|---|---|
| FP-193 | 80 | H | 2 4 | H | C₄H₉(n) | 18000 |
| FP-194 | 90 | H | 2 4 | H | —(CH₂CH₂O)₉—CH₃ | 16000 |
| FP-195 | 90 | CH₃ | 2 4 | F | C₆H₁₃(n) | 24000 |
| FP-196 | 80 | CH₃ | 1 6 | F | C₄H₉(n) | 18000 |
| FP-197 | 95 | H | 2 6 | H | —(C₃H₆O)₇—H | 21000 |
| FP-198 | 90 | CH₃ | 3 6 | H | —CH₂CH₂OH | 9000 |
| FP-199 | 75 | H | 1 8 | F | CH₃ | 12000 |
| FP-200 | 80 | H | 2 8 | H | CH₂CH(C₂H₅)C₄H₉(n) | 34000 |
| FP-201 | 90 | CH₃ | 2 8 | H | —(C₃H₆O)₇—H | 11000 |
| FP-202 | 80 | H | 3 8 | CH₃ | CH₃ | 18000 |
| FP-203 | 90 | H | 1 10 | F | C₄H₉(n) | 27000 |
| FP-204 | 95 | H | 2 10 | H | —(CH₂CH₂O)₉—CH₃ | 12000 |
| FP-205 | 85 | CH₃ | 2 10 | CH₃ | C₄H₉(n) | 20000 |
| FP-206 | 80 | H | 1 12 | H | C₆H₁₃(n) | 8000 |
| FP-207 | 90 | H | 1 12 | H | —(C₃H₆O)₁₃—H | 15000 |
| FP-208 | 60 | CH₃ | 3 12 | CH₃ | C₂H₆ | 12000 |
| FP-209 | 60 | H | 1 16 | H | CH₂CH(C₂H₅)C₄H₉(n) | 20000 |
| FP-210 | 80 | CH₃ | 1 16 | H | —(CH₂CH₂O)₂—C₄H₉(n) | 17000 |
| FP-211 | 90 | H | 1 18 | H | —CH₂CH₂OH | 34000 |
| FP-212 | 60 | H | 3 18 | CH₃ | CH₃ | 19000 |

When a low-refractivity layer is overcoated on the light-scattering layer and when the reduction in the surface energy is prevented at that time, then the antireflection capability of the film may be prevented from worsening. When the light-scattering layer is formed, it is desirable that a fluoropolymer is used so as to lower the surface tension of the coating liquid and to increase the surface uniformity of the layer formed, and it is also desirable that the producibility is kept high by employing a rapid coating method. After the formation of the light-scattering layer, the layer is then subjected to surface treatment such as corona treatment, UV treatment, thermal treatment, saponification treatment or solvent treatment, preferably to corona treatment whereby the surface free energy is prevented from lowering. Accordingly, the surface energy of the light-scattering layer before the formation of the low-refractivity layer thereon is controlled to fall within the above-mentioned range, and the intended object can be thereby attained.

We, the present inventors have confirmed that the scattered light intensity distribution determined by a goniophotometer is correlated with the effect of improving the viewing angle of displays. Specifically, when the light emitted by a backlight is diffused to a higher degree by the light-diffusive film disposed on the surface of the polarizer on the viewing side, then the viewing angle characteristics is more bettered. However, if the light is too much diffused, then it may cause some problems in that the backward scattering may increase and the front brightness may decrease, or the scattering may be too great and the image sharpness may be thereby lowered. Accordingly, it is necessary to control the scattered light intensity distribution to fall within a predetermined range. Given that situation, we, the present inventors have further studied and, as a result, have found that, in order to attain the desired visibility characteristic, the scattered light intensity at a light-outgoing angle of 30° in a scattered light profile, which is specifically correlated with the viewing angle-improving effect of displays, is preferably from 0.01% to 0.2%, more preferably from 0.02% to 0.15% relative to the light intensity at a light-outgoing angle of 0°.

The scattered light profile can be formed by analyzing the light-scattering film by the use of an automatically angle-varying photometer, GP-5 Model by Murakami Color Technology Laboratory.

A thixotropic agent may be added to the coating composition for forming the light-scattering layer in the invention. The thixotropic agent includes silica and mica having a size of at most 0.1 μm. In general, the amount of the agent to be added is preferably from 1 to 10 parts by mass or so relative to 100 parts by mass of the UV-curable resin in the composition.

The low-refractivity layer is described below.

<Low-Refractivity Layer>

The refractive index of the low-refractivity layer in the antireflection film of the invention is from 1.30 to 1.55, preferably from 1.35 to 1.45.

If the refractive index is smaller than 1.30, then the mechanical strength of the film may lower though the antireflection capability thereof may increase; but if larger than 1.55, then the antireflection capability of the film may greatly lower.

Preferably, the low-refractivity layer satisfies the following numerical formula (I) from the viewpoint of reducing the reflectivity of the layer.
(mλ/4)×0.7<n1×d1<(mλ/4)×1.3 (1)
wherein m is a positive odd number; n1 is the refractive index of the low-refractivity layer; d1 is the thickness (nm) of the low-refractivity layer; and X is a wavelength falling between 500 and 550 nm.

Satisfying the numerical formula (I) means the presence of m (this is a positive odd number, and is generally 1) that satisfies the numerical formula (I) within the above-mentioned wavelength range.

The material to form the low-refractivity layer is described below.

The low-refractivity layer is a cured film that is formed, for example, by applying a curable composition comprising a fluoropolymer as the principal ingredient thereof, onto a support, and drying and curing it thereon.

<Fluoropolymer for Low-Refractivity Layer>

Preferably, the fluoropolymer is as follows, from the viewpoint of improving the producibility in applying the polymer onto a roll film being conveyed in the form a web thereof and hardening it thereon: The cured coating film of the polymer has a kinematic friction factor of from 0.03 to 0.20, a contact angle to water of from 90 to 120°, and a pure water slip angle of at most 70°; and the polymer is crosslinkable when exposed to heat or ionizing radiations.

In case where the antireflection film of the invention is fitted to an image display device, seals and adhesive memo sheets stuck thereto may be more readily peeled off when the peeling strength of the film from a commercially-available adhesive tape is lower. Therefore, the peeling strength of the film is preferably at most 500 gf, more preferably at most 300 gf, most preferably at most 100 gf.

The film is more hardly scratched when its surface hardness as measured with a microhardness meter is higher. Therefore, the surface hardness of the film is preferably at least 0.3 GPa, more preferably at least 0.5 GPa.

The fluoropolymer for use in the low-refractivity layer is a fluoropolymer that contains a fluorine atom within a range of from 35 to 80% by mass and contains a crosslinking or polymerizing functional group, including, for example, hydrolyzates and hydrolytic dewatering condensates of perfluoroalkyl group-containing silane compounds (e.g., heptadecafluoro-1,1,2,2-tetrahydrodecyl)triethoxysilane), as well as fluoro-copolymers that comprise, as the constitutive components thereof, fluorine-containing monomer units and crosslinking-reactive units. Preferably, the backbone chain of the fluoro-copolymers is formed of only carbon atoms. Preferably, in other words, the backbone chain of the copolymers does not contain an oxygen atom and a nitrogen atom.

Specific examples of the fluorine-containing monomer units are fluoro-olefins (e.g., fluoroethylene, vinylidene fluoride, tetrafluoroethylene, perfluoro-octylethylene, hexafluoropropylene, perfluoro-2,2-dimethyl-1,3-dioxol), partially or completely fluorinated alkyl ester derivatives of (meth)acrylic acid (e.g., Biscoat 6FM (by Osaka Yuki Kagaku), M-2020 (by Daikin)), and completely or partially fluorinated vinyl ethers. Preferred are perfluoro-olefins; and more preferred is hexafluoropropylene from the viewpoint of the refractivity, solubility, transparency and availability thereof.

The crosslinking reactive units include structural units formed through polymerization of a monomer that intrinsically has a self-crosslinking functional group in the molecule, such as glycidyl (meth)acrylate or glycidyl vinyl ether; and structural units formed through polymerization of a monomer having a carboxyl group, a hydroxyl group, an amino group or a sulfo group (e.g., (meth)acrylic acid, methylol (meth)acrylate, hydroxyalkyl (meth)acrylate, allyl acrylate, hydroxyethyl vinyl ether, hydroxybutyl vinyl ether, maleic acid, crotonic acid), followed by introduction thereinto a crosslinking reactive group such as (meth)acryloyl group through polymerization reaction (for example, the group may be introduced according to a method of reacting acrylic acid chloride on a hydroxyl group).

Except the above-mentioned fluorine-containing monomer units and crosslinking reactive units, the copolymer may be further copolymerized with any other monomer not having a fluorine atom to thereby introduce any other polymer units thereinto, from the viewpoint of the solubility of the copolymer in solvent and of the transparency of the film formed. Not specifically defined, the comonomer includes, for example, olefins (e.g., ethylene, propylene, isoprene, vinyl chloride, vinylidene chloride), acrylates (e.g., methyl acrylate, methyl acrylate, ethyl acrylate, 2-ethylhexyl acrylate), methacrylates (e.g., methyl methacrylate, ethyl methacrylate, butyl methacrylate, ethylene glycol dimethacrylate), styrene derivatives (e.g., styrene, divinylstyrene, vinyltoluene, α-methylstyrene), vinyl ethers (e.g., methyl vinyl ether, ethyl vinyl ether, cyclohexyl vinyl ether), vinyl esters (e.g., vinyl acetate, vinyl propionate, vinyl cinnamate), acrylamides (e.g., N-tert-butylacrylamide, N-cyclohexylacrylamide), methacrylamides, acrylonitrile derivatives.

A curing agent may be suitably added to the fluoropolymer, for example, as in JP-A 10-25388 and 10-147739.

The fluoropolymer especially useful in the invention is a random copolymer of a perfluoroethylene with a vinyl either or vinyl ester. Especially preferably, the polymer has a group crosslinkable by itself (e.g., radical-reactive group such as (meth)acryloyl group, and ring-cleaving polymerizing group such as epoxy group, oxetanyl group).

It is desirable that the crosslinking-reactive group-containing polymerization units account for from 5 to 70 mol %, more preferably from 30 to 60 mol % of all the polymerization units.

One preferred embodiment of the fluoropolymer for the low-refractivity layer for use in the invention is a copolymer of the following formula (1):

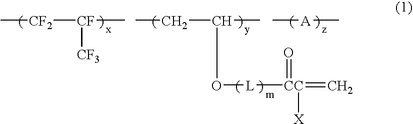

In formula (1), L represents a linking group having from 1 to 10 carbon atoms, preferably from 1 to 6 carbon atoms, more preferably from 2 to 4 carbon atoms, and it may have a linear structure, or a branched structure, or a cyclic structure, and it may contain a hetero atom selected from O, N and S.

Preferred examples of L are *—(CH₂)₂—O—**, *—(CH₂)₄—NH—**, *—(CH₂)₄—O—**, *—(CH₂)₆—O—**, *—(CH₂)₂—O—(CH₂)₂—**, *—CONH—(CH₂)₃—**, *—CH₂CH(OH)CH₂—O—**, *—CH₂CH₂OCONH(CH₂)₃—O—** (in which * indicates the linking site on the backbone structure side; and ** indicates the linking site on the (meth)acryloyl group side). m indicates 0 or 1.

In formula (1), X represents a hydrogen atom or a methyl group. From the viewpoint of the curing reactivity of the polymer, X is preferably a hydrogen atom.

In formula (1), A represents a repetitive unit derived from a vinyl monomer, and, not specifically defined, it may be any polymerization component of a monomer copolymerizable with hexafluoropropylene. From the viewpoint of the adhesiveness of the polymer to substrates, the Tg thereof (this contributes to the film hardness), the solubility thereof in solvent, the transparency thereof, the lubricity thereof, and the dust resistance and the stain resistance thereof, the unit A may be suitably selected. Depending on the object of the polymer, one or more different types of vinyl monomers may form the repetitive unit A.

Preferred examples of the monomer are vinyl ethers such as methyl vinyl ether, ethyl vinyl ether, t-butyl vinyl ether, cyclohexyl vinyl ether, isopropyl vinyl ether, hydroxyethyl vinyl ether, hydroxybutyl vinyl ether, glycidyl vinyl ether, allyl vinyl ether; vinyl esters such as vinyl acetate, vinyl propionate, vinyl butyrate; (meth)acrylates such as methyl (meth)acrylate, ethyl (meth)acrylate, hydroxyethyl (meth)acrylate, glycidyl methacrylate, allyl (meth)acrylate, (meth)acryloyloxypropyltrimethoxysilane; styrene derivatives such as styrene, p-hydroxymethylstyrene; unsaturated carboxylic acids and their derivatives such as crotonic acid, maleic acid, itaconic acid. More preferred are vinyl ether derivatives and vinyl ester derivatives; and even more preferred are vinyl ether derivatives.

x, y and z each indicate the mol % of the constitutive components, and satisfy the following: 30≦x≦60, 5≦y≦70, 0≦z≦65. Preferably, 35≦x≦55, 30≦y≦60, 0≦z≦20; more preferably 40≦x≦55, 40≦y≦55, 0≦z≦10. x+y+z=100.

A more preferred embodiment of the copolymer for use in the invention is a copolymer of the following formula (2):

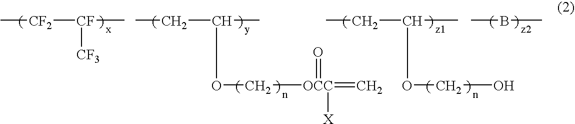

In formula (2), X has the same meaning as that in formula (1), and its preferred range is also the same as in formula (1).

n indicates an integer of 2≦n≦10, preferably 2≦n≦6, more preferably 2≦n≦4.

B represents a repetitive unit derived from a vinyl monomer, and it may be composed of a single composition or multiple compositions. For its examples, referred to are those mentioned hereinabove for A in formula (1).

x, y, z1 and z2 each indicate the mol % of the repetitive units. Preferably, x and y satisfy the following: 30≦x≦60, 5≦y≦70; more preferably 35≦x≦55, 30≦y≦60; even more preferably 40≦x≦55, 40≦y≦55. z1 and z2 are as follows: 0≦z1≦65 and 0≦z2≦65. Preferably, 0≦z1≦30 and 0≦z2≦10; more preferably 0≦z1≦10 and 0≦z2≦5. x+y+z1+z2=100.

The copolymers of formula (1) or (2) can be produced, for example, by introducing a (meth)acryloyl group into a copolymer that contains a hexafluoropropylene component and a hydroxyalkyl vinyl ether component, according to any of the above-mentioned methods. The reprecipitation solvent that may be used in this case is preferably isopropanol, hexane or methanol.

Preferred examples of the copolymers of formula (1) or (2) are given in JP-A 2004-45462, paragraphs [0035] to [0047]. The copolymers for use herein may be produced according to the method described in the patent publication.

The curable composition for forming the low-refractivity layer preferably contains (A) the above-mentioned fluoropolymer, (B) inorganic particles, and (C) a hydrolyzate of an organosilane compound mentioned below, or its partial condensate, or a mixture of both the two.

<Inorganic Particles for Low-Refractivity Layer>

The coating amount of inorganic particles is preferably from 1 mg/m² to 100 mg/m², more preferably from 5 mg/m² to 80 mg/m², even more preferably from 10 mg/m² to 60 mg/m². When the coating amount thereof falls within the range as above, then the inorganic particles are effective for improving the scratch resistance of the layer formed, the surface of the low-refractivity layer formed is not roughened, and therefore the black appearance of the layer is not worsened and the integrated reflection of the layer is not also worsened.

As added to the low-refractivity layer, the inorganic particles preferably have a low refractive index.

For example, they are particles of magnesium fluoride or silica. More preferred are silica particles in view of the refractive index, the dispersion stability and the cost thereof.

The mean particle size of the inorganic particles is preferably from 30% to 100%, more preferably from 35% to 80%, even more preferably from 40% to 60% of the thickness of the low-refractivity layer. Accordingly, when the thickness of the low-refractivity layer is 100 nm, then the particle size of silica particles for the inorganic particles is preferably from 30 nm to 100 nm, more preferably from 35 nm to 80 nm, even more preferably from 40 nm to 60 nm.

When the particle size thereof falls within the range as above, then the inorganic particles may be effective for improving the scratch resistance of the layer formed, and in addition, since they do not cause surface protrusions of the low-refractivity layer formed, the black appearance of the layer is not worsened and the integrated reflection of the layer is not also worsened. The inorganic particles may be crystalline or amorphous, and they may be monodispersed particles or may be even aggregated particles so far as they fall within the predetermined particle size range. Regarding their morphology, they are most preferably spherical, but may be amorphous with no problem.

The mean particle size of the inorganic particles may be determined with a Coulter counter.

For further preventing the increase in the refractive index of the low-refractivity layer, the inorganic particles to be in the layer are preferably hollow-structured particles. Also preferably, the refractive index of the inorganic particles is from 1.17 to 1.40, more preferably from 1.17 to 1.35, even more preferably from 1.17 to 1.30. The refractive index as referred to herein for the particles means the refractive index of the entire particles. In hollow-structured inorganic particles, therefore, the refractive index is not for the inorganic shell part thereof alone. In this case, when the radius of the hollow of the particles is represented by a and the radius of the particle shell is by b, then the porosity x of the particles to be represented by the following numerical formula (II) is preferably from 10 to 60%, more preferably from 20 to 60%, most preferably from 30 to 60%.
x=(4πa³/3)/(4πb³/3)×100. (II)

When the refractive index of the hollow inorganic particles is further lowered and the porosity thereof is further increased, then the thickness of the shell may be thin and the mechanical strength of the particles may be low. Therefore, from the viewpoint of the scratch resistance thereof, low-refractivity particles having a refractive index of lower than 1.17 are impracticable.

The refractive index of the inorganic particles is determined with an Abbe's refractometer (by Atago).

At least one type of inorganic particles having a mean particle size of less than 25% of the thickness of the low-refractivity layer (these are referred to as “small-size inorganic fine particles”), which are smaller than the inorganic particles mentioned hereinabove (these are referred to as “large-size inorganic particles”), may be combined with the large-size inorganic particles having the above-mentioned, preferred particle size.

Since the small-size inorganic particles may exist in the space between the large-size inorganic particles, they may serve as a fixer for the large-size inorganic particles.

The mean particle size of the small-size inorganic particles is preferably from 1 nm to 20 nm, more preferably from 5 nm to 15 nm, even more preferably from 10 nm to 15 nm, when the thickness of the low-refractivity layer containing them is 100 nm. Using the inorganic particles of the type is preferred in point of the cost of the materials and of the effect of the particles serving as a fixer.

As so mentioned hereinabove, the large-size inorganic particles are preferably hollow-structured particles having a mean particle size of from 30 to 100% of the thickness of the low-refractivity layer and having a refractive index of from 1.17 to 1.40.

The inorganic particles may be processed for physical surface treatment such as plasma discharge treatment or corona discharge treatment, or for chemical surface treatment with surfactant or coupling agent, in order to ensure their dispersion stability in dispersions or coating liquids and in order to enhance their affinity and bonding ability to binder components. More preferably, coupling agent is used for the treatment. The coupling agent is preferably an alkoxymetal compound (e.g., titanium coupling agent, silane coupling agent). Above all, treatment with a silane coupling agent is especially effective.

The coupling agent is used for surface treatment as a surface-treating agent for the inorganic particles to be in the low-refractivity layer before a coating liquid for the layer is prepared, but it is preferably added to the coating liquid for the layer as an additive thereto while the coating liquid is prepared, and it is thereby added to the layer.

It is desirable that the inorganic particles are previously dispersed in a medium before the surface treatment, for reducing the load of the surface treatment.

The organosilane compound (C) is described below.

(C) Organo-Silane Compounds

It is preferred from the viewpoint of scratch resistance that at least one layer among the layers constituting the film of the present invention contains at least one component, i.e., so-called sol component (Hereinafter this nomenclature may be sometimes used.) comprising a hydrolyzed product and/or a partial condensation product of an organo-silane compound.

In particular, in an antireflection film, it is specifically preferred to have such sol component contained in both of the low-refractivity layer and the functional layer for the purpose of simultaneously achieving antireflection capability and scratch resistance. This sol component becomes a part of the binder of the above-cited layer by forming a cured product via condensation proceeding during the drying and heating steps subsequent to the coating of the coating mixture. In the case where the cured product has a polymerizable unsaturated bond, a binder having a three-dimensional structure is formed by the irradiation of an active ray.

The organo-silane compounds represented by the following formula 1 are preferred.
(R¹)ₘ—Si(X)₄₋ₘ Formula 1

In the above formula 1, R¹ represents an optionally substituted alkyl or aryl group. As the alkyl group, those having 1 to 30 carbon atoms are preferred, those having 1 to 16 carbon atoms are more preferred, and those having 1 to 6 carbon atoms are particularly preferred. As the specific example of the alkyl group, methyl, ethyl, propyl, isopropyl, hexyl, decyl, and hexadecyl are mentioned. As the aryl group, phenyl and naphthyl are mentioned, phenyl being preferred.

X represents a hydroxy group or a hydrolyzable group, including, for example, alkoxy groups (those with 1 to 5 carbon atoms being preferred, exemplified by methoxy and ethoxy), halogen atoms (for example, Cl, Br and I), and those represented by R²COO (wherein R² preferably represents a hydrogen atom or an alkyl group with 1 to 6 carbon atoms, exemplified by CH₃COO and C₂H₅COO). Among these, an alkoxy group is preferred, and a methoxy or ethoxy group is particularly preferred.

m indicates an integer of from 1 to 3, preferably from 1 to 2.

When a plurality of X exist, they may be the same or different from each other.

The substituent included in R¹, though not specifically restricted, is a halogen atom (fluorine, chlorine or bromine), hydroxy group, a mercapto group, a carboxyl group, epoxy group, an alkyl group (methyl, ethyl, i-propyl, propyl or t-butyl), an aryl group (phenyl or naphthyl), an aromatic heterocyclic group (furyl, pyrazolyl or pyridyl), an alkoxy group (methoxy, ethoxy, i-propoxy or hexyloxy), an aryloxy group (phenoxy), an alkylthio group (methylthio or ethylthio), an arylthio group (phenylthio), an alkenyl group (vinyl or 1-propenyl), an acyloxy group (acetoxy, acryloyloxy or methacryloyloxy), an alkoxycarbonyl group (methoxycarbonyl or ethoxycarbonyl), an aryloxycarbonyl group (phenoxycarbonyl), a carbamoyl group (carbamoyl, N-methylcarbamoyl, N,N-dimethylcarbamoyl or N-methyl-N-octylacarbamoyl), an acylamino group (acetylamino, benzoylamino, acrylamino or methacrylamino). And these substituents may further be substituted.

R¹ is preferably a substituted alkyl or aryl group, and among them, an organo-silane compound having the vinyl-polymerizable substituent represented by the following formula 2 is preferred.

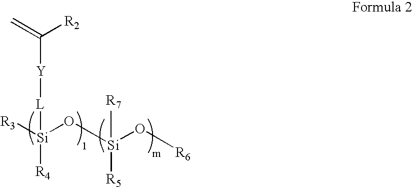

In the above formula 2, R₂ represents a hydrogen atom, methyl group, methoxy group, alkoxycarbonyl group, cyano group, a fluorine atom or a chlorine atom. As the alkoxycarbonyl group, methoxycarbonyl and ethoxycarbonyl are mentioned. A hydrogen atom, methyl group, methoxy group, methoxycarbonyl group, cyano group, a fluorine atom and a chlorine atom are preferred. A hydrogen atom, methyl group, methoxycarbonyl group, a fluorine atom and a chlorine atom are more preferred. A hydrogen atom and methyl group are particularly preferred.

Y represents a single bond or *—COO—**, *—CONH—**, or *—O—**, whereby a single bond, *—COO—**, and *—CONH—** are preferred, a single bond and *—COO—** are more preferred, and *—COO—** is particularly preferred. The mark * represents the position connecting to ═C(R₁)—, and the mark ** represents the position connecting to L.

L represents a divalent connecting chain. Concretely, an optionally substituted alkylene group, an optionally substituted arylene group, an alkylene group internally having a connecting group (for example, ether, ester or amide), an optionally substituted arylene group internally having a connecting group are preferred. And, an unsubstituted alkylene group, an unsubstituted arylene group, and an alkylene group internally having an ether or ester connecting group are more preferred. In particular, an unsubstituted alkylene group and an alkylene group internally having an ether or ester connecting group are preferred. As the substituent, halogen, hydroxyl group, mercapto group, carboxyl group, epoxy group, an alkyl group and aryl group are mentioned whereby these substituents may further be substituted.

In formula 2, l (small letter ‘l’) and m represent molar fractions whereby l represents the number satisfying the numerical formula l=100−m, in which m represents a number of from 0 to 50. m is more preferably from 0 to 40, particularly preferably from 0 to 30.

R₃ to R₅ each preferably represent a halogen atom, hydroxy group, an unsubstituted alkoxy group or a unsubstituted alkyl group. As R₃ to R₅, a chlorine atom, hydroxy group or an unsubstituted alkoxy group with 1 to 6 carbon atoms is preferred; hydroxy group or an alkoxy group with 1 to 3 carbon atoms is more preferred, and hydroxy group or methoxy group is particularly preferred.

R₆ represents a hydrogen atom or an alkyl group. As the alkyl group, methyl or ethyl is preferred.

R₇ represents an optionally substituted alkyl or aryl group. Among them, an alkyl group with 1 to 3 carbon atoms is preferred, and methyl group is particularly preferred.

Two or more of the compound represented by formula 1 may be used in combination. In particular, the compound of formula 2 can be synthesized with use of two compounds of formula 1 as the starting materials. In the following, some concrete examples of the starting material for the compounds represented by formulae 1 and 2 are shown, but the scope of the invention should not be limited thereto.

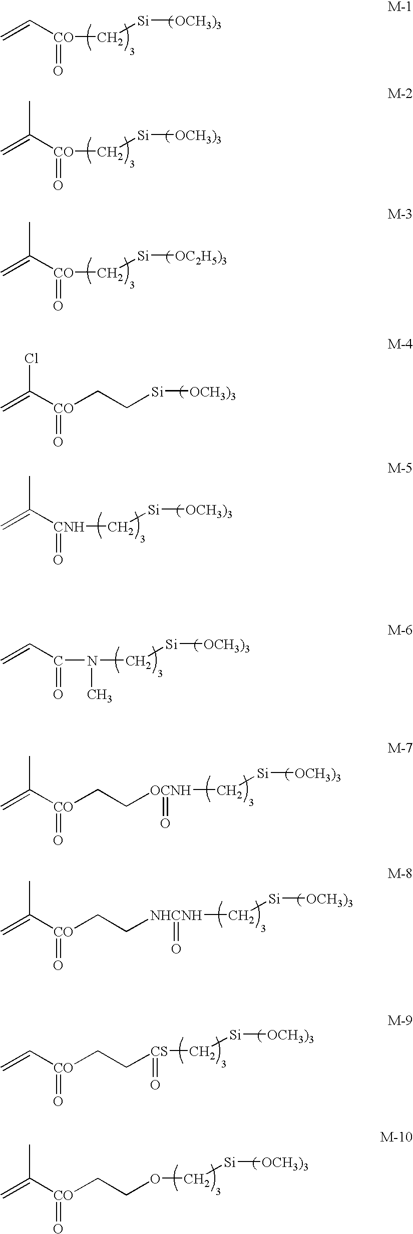

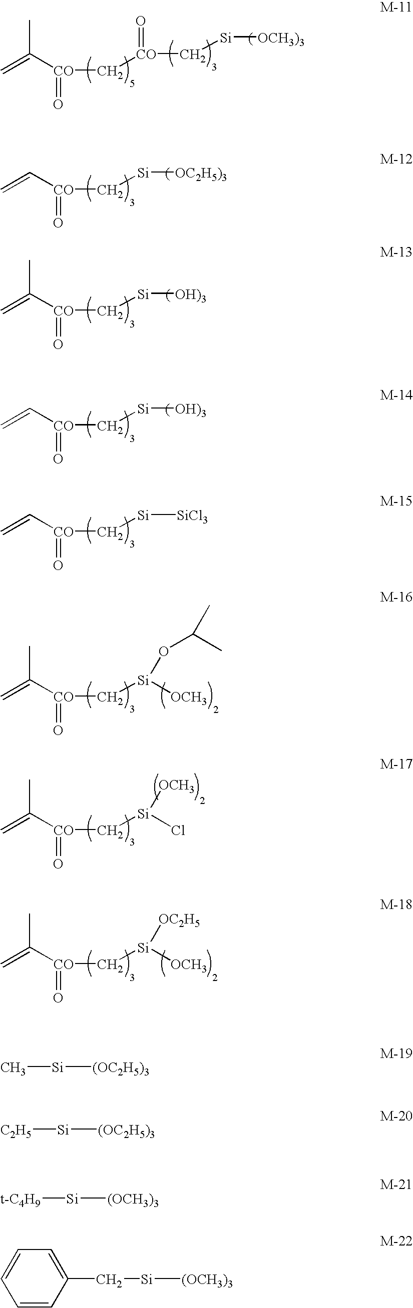

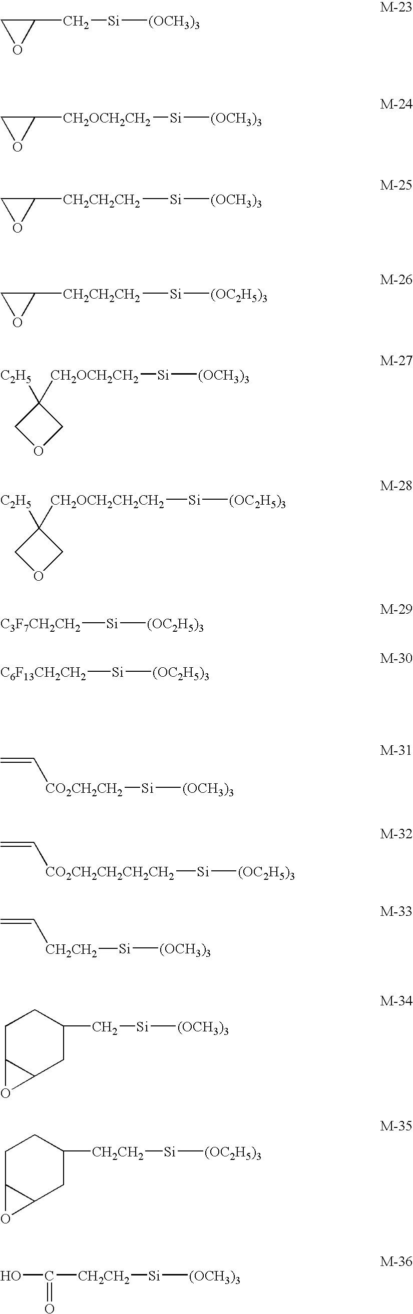

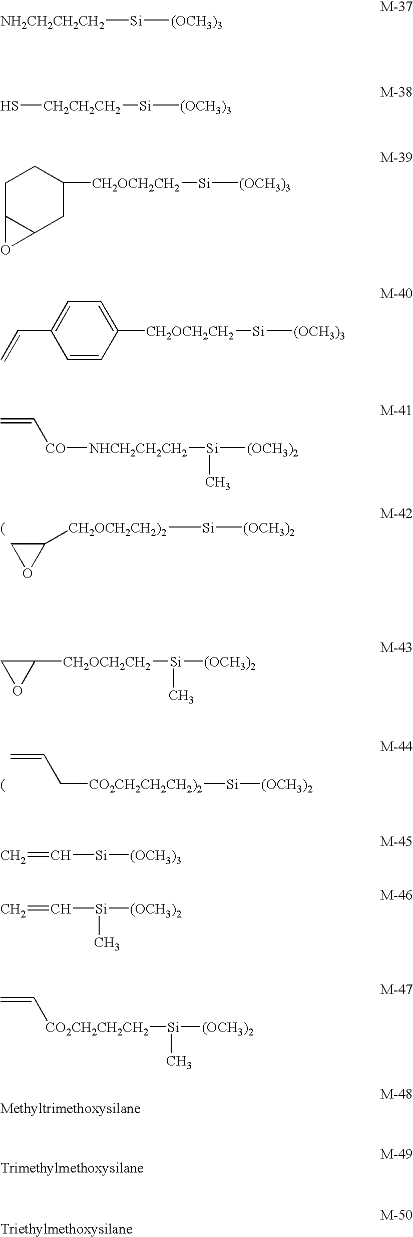

Among these compounds, (M-1), (M-2), (M-19), (M-20), (M-21), (M-24), (M-30), (M-48) and (M-49) are preferred. As the organo-silane having a polymerizable group, (M-1), (M-2) and (M-25) are preferred. One compound selected from those polymerizable group-containing ones may be used in combination with a compound free of polymerizable group.

The amount of organo-silane compound is preferably from 0.1 to 50% by mass, more preferably 0.5 to 20% by mass, most preferably 1 to 10% by mass of the total solid content of the low-refractivity layer.

[Other Substances that May be in Curable Composition for Low-Refractivity Layer]

The curable composition may be prepared by optionally adding various additives and a radical polymerization initiator or a cationic polymerization initiator to the above-mentioned (A) fluoropolymer, (B) inorganic particles and (C) hydrolyzate or its partial condensate of an organosilane compound or a mixture of both the two, followed by dissolving them in a suitable solvent. In the resulting solution, the concentration of the solid components may be suitably determined depending on the use of the solution, but is generally from 0.01 to 60% by mass or so, preferably from 0.5 to 50% by mass or so, more preferably from 1 to 20% by mass or so.

The low-refractivity layer may contain a small amount of a curing agent of, for example, polyfunctional (meth)acrylate compounds, polyfunctional epoxy compounds, polyisocyanate compounds, aminoplasts, polybasic acids and their anhydrides, from the viewpoint of the interlayer adhesiveness between the low-refractivity layer and the underlying layer that is in direct contact with the low-refractivity layer. When the curing agent is added, its amount is preferably at most 30% by mass, more preferably at most 20% by mass, even more preferably at most 10% by mass of the total solid content of the low-refractivity layer film.

For making the low-refractivity layer have various properties of soiling resistance, waterproofness, chemical resistance and lubricity, an anti-soiling agent and a lubricant of, for example, known silicone compounds or fluorine-containing compounds may be suitably added to the layer. When the additive is added to the layer, then its amount is preferably from 0.01 to 20% by mass, more preferably from 0.05 to 10% by mass, even more preferably from 0.1 to 5% by mass of the total solid content of the layer.

Preferred examples of the silicone compound are those having a substituent at least in any of terminals and side branches of a compound chain that contains multiple dimethylsilyloxy units as repetitive units. The compound chain containing repetitive dimethylsilyloxy units may contain any other structural unit than dimethylsilyloxy units. Preferably, the compound contains multiple substituents that may be the same or different. Examples of preferred substituents are those containing any of an acryloyl group, a methacryloyl group, a vinyl group, an aryl group, a cinnamoyl group, an epoxy group, an oxetanyl group, a hydroxyl group, a fluoroalkyl group, a polyoxyalkylene group, a carboxyl group, and amino group. Though not specifically defined, the molecular weight of the compound is preferably at most 100,000, more preferably at most 50,000, most preferably from 3000 to 30,000. Also not specifically defined, the silicone atom content of the silicone compound is preferably at least 18.0% by mass, more preferably from 25.0 to 37.8% by mass, most preferably from 30.0 to 37.0% by mass. Examples of the preferred silicone compounds are Shin-etsu Chemical's X-22-174DX, X-22-2426, X-22-164B, X-22-164C, X-22-170DX, X-22-176D, X-22-1821 (all trade names), Chisso's FM-0725, FM-7725, FM-4421, FM-5521, FM-6621, FM-1121, and Gelest's DMS-U22, RMS-033, RMS-083, UMS-182, DMS-H21, DMS-H31, HMS-301, FMS-121, FMS-123, FMS-131, FMS-141, FMS-221 (all trade names), to which, however, the invention is not limited.

The fluorine-containing compound is preferably a fluoroalkyl group-having compound. Preferably, the fluoroalkyl group has from 1 to 20 carbon atoms, more preferably from 1 to 10 carbon atoms, and it may have a linear structure (e.g., —CF₂CF₃, CH₂(CF₂)₄H, —CH₂(CF₂)₈CF₃, —CH₂CH₂(CF₂)₄), or a branched structure (e.g., —CH(CF₃)₂, —CH₂CF(CF₃)₂, —CH(CH₃)CF₂CF₃, —CH(CH₃)(CF₂)₅CF₂H), or an alicyclic structure (preferably 5-membered or 6-membered, e.g., a per-fluorocyclohexyl group, a perflulrocyclopentyl group, or an alkyl group substituted with any of these); or it may have an ether bond (e.g., —CH₂OCH₂CF₂CF₃, —CH₂CH₂OCH₂C₄F₈H, —CH₂CH₂OCH₂CH₂C₈F₁₇, —CH₂CH₂OCF₂CF₂OCF₂CF₂H). One molecule of the compound may have multiple fluoroalkyl groups.

Preferably, the fluorine-containing compound contains a substituent that contributes to the formation of a bond to the film of the low-refractivity layer or to the compatibility with the film. Also preferably, the compound has multiple substituents of the type, which may be the same or different. Examples of the preferred substituent are an acryloyl group, a methacryloyl group, a vinyl group, an aryl group, a cinnamoyl group, an epoxy group, an oxetanyl group, a hydroxyl group, a polyoxyalkylene group, a carboxyl group, and an amino group. The fluorine-containing compound may be a polymer or an oligomer with a compound not containing a fluorine atom, and its molecular weight is not specifically defined. Also not specifically defined, the fluorine atom content of the fluorine-containing compound is preferably at least 20% by mass, more preferably from 30 to 70% by mass, most preferably from 40 to 70% by mass. Examples of the preferred fluorine-containing compound are Daikin Chemical Industry's R-2020, M-2020, R-3833, M-3833 (all trade names), Dai-Nippon Ink's Megafac F-171, F-172, F-179A, Diffenser MCF-300 (all trade names), to which, however, the invention is not limited.

For making the layer have dust-resistant and antistatic properties, a dust-resistant or antistatic agent such as known cationic surfactants or polyoxyalkylene compounds may also be added to the layer. The dust-resistant and the antistatic properties may be a part of the function of the structural units of the above-mentioned silicone compound and the fluorine-containing compound. When the dust-resistant agent and the antistatic agent are added to the layer, its amount is preferably from 0.01 to 20% by mass, more preferably from 0.05 to 10% by mass, even more preferably from 0.1 to 5% by mass of the total solid content of the low-refractivity layer. Examples of preferred compounds for the agent are Dai-Nippon Ink's Megafac F-150 (trade name) and Toray-Dow Corning's SH-3748 (trade name), but these are not limitative.

<Transparent Support>

For the transparent support of the light-scattering film or the antireflection film of the invention, preferred is a plastic film. The polymer to form the plastic film includes cellulose acylates (e.g., triacetyl cellulose, diacetyl cellulose, cellulose acetate propionate, cellulose acetate butyrate, typically Fiji Photo Film's TAC-TD80U, TD80UL), polyamides, polycarbonates, polyesters (e.g., polyethylene terephthalate, polyethylene naphthalate), polystyrenes, polyolefins, norbornene resins (Arton: trade name by JSR), amorphous polyolefins (Zeonex: trade name by Nippon Zeon). Of those, preferred are triacetyl cellulose, polyethylene terephthalate, norbornene resins, amorphous polyolefins; and more preferred is triacetyl cellulose.

Single-layered or multi-layered cellulose acylate films may be used herein. The single-layered cellulose acylate film may be produced according to a drum-casting or band-casting process as in JP-A 7-11055. The latter multi-layered cellulose acylate film may be produced according to a co-casting process as in JP-A 61-94725 and JP-B 62-43846. Briefly, starting flakes are dissolved in a solvent of halogenohydrocarbons (e.g., dichloromethane), alcohols (e.g., methanol, ethanol, butanol), esters (e.g., methyl formate, methyl acetate), ethers (e.g., dioxane, dioxolane, diethyl ether), and various additives of plasticizer, UV absorbent, antioxidant, lubricant and peeling promoter are optionally added thereto to prepare a solution (dope). The dope is cast onto a support of a horizontal endless metal belt or a rotary drum, through a dope supply unit (die). In this stage, a single dope is cast onto it to form a single-layered film; and a high-concentration cellulose ester dope is co-cast along with low-concentration dopes on both sides thereof, onto the support to form a multi-layered film thereon. Then, after the film has been dried in some degree on the support and has become tough, it is peeled away from the support, and then led through a drying zone by the use of a conveyor system so that the solvent is evaporated away from it.

Dichloromethane is one typical example of the solvent to dissolve cellulose acylate in the manner as above. However, from the viewpoint of the global environment protection and the working environment safety, it is desirable that the solvent does not substantially contain a halogenohydrocarbon such as dichloromethane. The wording “does not substantially contain” means that the proportion of the halogenohydrocarbon in the organic solvent is less than 5% by mass (preferably less than 2% by mass).

Various types of cellulose acylate films (e.g., triacetylcellulose film) mentioned above and methods for producing them are described in Hatsumei Kyokai's Disclosure Bulletin No. 2001-1745 (issued Mar. 15, 2001).

Preferably, the thickness of the cellulose acylate film for use herein is from 40 μm to 120 μm. In view of the handling aptitude and the coating aptitude thereof, the thickness of the film is more preferably around 80 μm. However, the recent tendency towards thinner display devices requires thinner polarizers, and from the viewpoint of the need for such thinner polarizers, it is desirable that the thickness of the cellulose acylate film is from 40 μm to 60 μm or so. When such a thin cellulose acylate film is used as the transparent support of the light-scattering film or the antireflection film of the invention, it is desirable that the solvent for the layer that is to be formed directly on the cellulose acylate film, as well as the thickness of the layer and the crosslinking shrinkage thereof is optimized to thereby evade the problem that may detract from the above-mentioned handling aptitude and the coating aptitude of the film support.

<Other Layers>

Any other layers may be disposed between the transparent support and the light-scattering layer in the invention. They are, for example, an antistatic layer (this will be necessary when the surface resistivity value on the display side must be lowered or when the display surface must be resistant to dust adhesion thereto), a hard coat layer (this will be necessary when the light-scattering layer alone could not satisfy the intended hardness), a moisture-proof layer, an adhesion-improving layer, and an interference unevenness-preventing layer.

These layers may be formed in any known methods.

The light-scattering film of the invention may be fabricated according to the method mentioned below, to which, however, the invention is not limited.

[Preparation of Coating Liquid]

First prepared is a coating liquid that contains the constitutive components of the intended layer. In this step, the evaporation of the solvent in the coating liquid may be minimized to thereby prevent the increase in the water content of the coating liquid. Preferably, the water content of the coating liquid is at most 5%, more preferably at most 2%. The solvent evaporation may be prevented by improving the good seal of the tank where the materials are put and stirred, and by minimizing the air contact area of the coating liquid during the liquid transfer operation. If desired, a method may be employed for reducing the water content of the coating liquid during or before or after the application of the liquid.

Preferably, the coating liquid to form the light-scattering layer is filtered so as to remove almost all (at least 90%) the impurities that correspond to the dry film thickness (50 nm to 120 nm or so) of the low-refractivity layer that is to be formed directly on the light-scattering layer. Since the translucent particles to impart the light-scatterability to the light-scattering layer are equal to or larger than the film thickness of the low-refractivity layer, the filtration is preferably effected for the intermediate liquid containing all the materials except the translucent particles. In case where a filter capable of removing impurities having such a small size is unavailable, it is desirable that the coating liquid is filtered at least so as to remove almost all the impurities that correspond to the wet film thickness (1 to 10 μm or so) of the layer that is to be formed directly on the light-scattering layer. According to the method, the spot defects in the layer directly formed on the light-scattering layer may be reduced.

[Coating]

Next, the coating liquid for forming the light-scattering layer and optionally that for forming the low-refractivity layer are applied onto a transparent support according to an extrusion process (die-coating process), then heated and dried thereon. Next, this is exposed to at least any of light or heat so that the monomer to form the light-scattering layer or the low-refractivity layer is polymerized and cured. Accordingly, the intended light-scattering layer or low-refractivity layer is thereby formed.

From the viewpoint of high production speed thereof, in general, such an extrusion process (die-coating process) is preferably employed. In particular, a die coater is preferably used for a region that has a small wet coating amount (at most 20 cc/m²) such as the light-scattering layer and the antireflection layer in the invention. This is described below.

<Constitution of Die Coater>

FIG. 2 is a cross-sectional view of a coater with a slot die, with which the invention is carried out. The coater 10 jets out a coating liquid 14 as a bead 14a, through the tip lip 17 of the slot die 13, onto the web (support) W continuously running as supported by a backup roll 11, whereby a coating film 14b is formed on the web W.

A pocket 15 and a slot 16 are formed inside the slot die 13. The cross section of the pocket 15 is formed of a curve and a line. For example, as in FIG. 2, it may be nearly circular or semicircular. The pocket 15 is a space for holding a coating liquid therein, and is so designed that its cross section is expanded in the cross direction of the slot die 13, and, in general, its effective extension length is equal to or somewhat larger than the coating width. The supply of the coating liquid 14 to the pocket 15 is effected from the side face of the slot die 13 or from the face center on the side opposite to the side of the slot opening 16a. A stopper is provided to the pocket 15 so as to prevent the coating liquid 14 from leaking out.

The slot 16 is a passage for the coating liquid 14 from the pocket 15 to the web W, and like the pocket 15, it has a cross-section profile in the cross direction of the slot die 13. The opening 16a positioned on the web side is generally so controlled that its width may be nearly the same as the coating width, by the use of a width control plate (not shown). At the slot tip, the angle between the slot 16 and the tangential line in the web-running direction of the backup roll 11 is preferably from 30° to 90°.

The tip lip 17 of the slot die 13 at which the opening 16a of the slot 16 is positioned is tapered, and the tapered tip is leveled to be a land 18. Of the land 18, the upstream in the running direction of the web W relative to the slot 16 is referred to as an upstream lip land 18a, and the downstream is as a downstream lip land 18b.

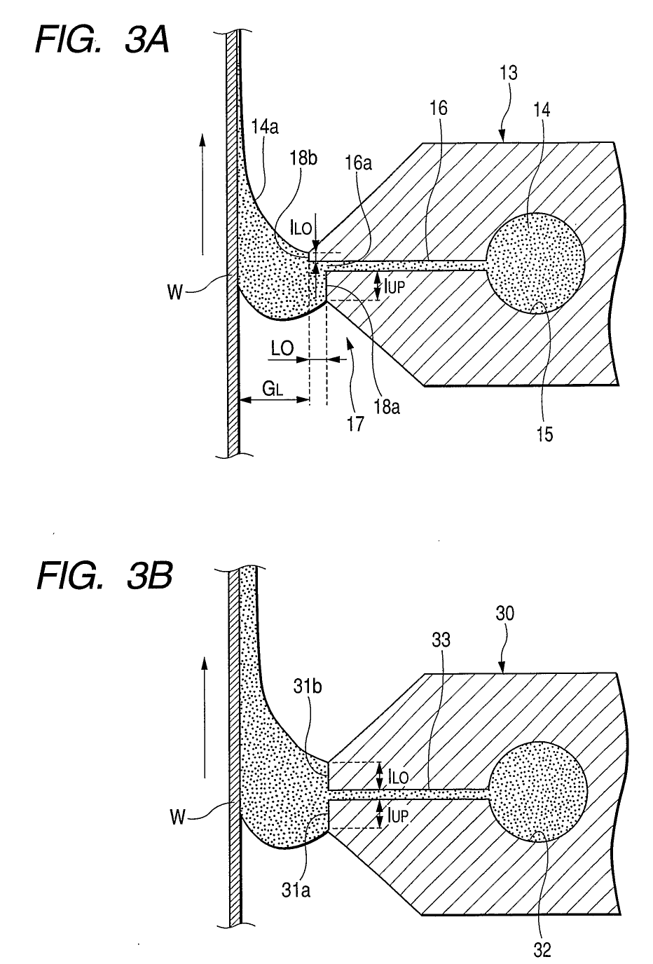

FIG. 3 shows the cross-sectional profile of the slit die 13, as compared with that of an ordinary one. (A) shows the slit die 13 for use in the invention; and (B) shows an ordinary slot die 30. In the ordinary slot die 30, the distance between the web and the upstream lip land 31a is the same as that between the web and the downstream lip land 31b. In (B), the reference numeral 32 indicates a pocket and 33 indicates a slot. As opposed to this, in the slot die 13 for use in the invention, the downstream lip land length I_{LO} is short, and accordingly, it enables accurate coating to form a wet film thickness of 20 μm or less.

Though not specifically defined, the land length I_{UP} of the upstream lip land 18a is preferably from 500 μm to 1 mm. The land length I_{LO} of the downstream lip land 18b may be from 30 μm to 100 μm, preferably from 30 μm to 80 μm, more preferably from 30 μm to 60 μm. In case where the downstream lip land length I_{LO} is shorter than 30 μm, then the edge or the land of the tip lip may be readily chipped and the coating film may have streaks, and at last the coating may be impossible. If so, in addition, there may occur other problems in that the wet line position on the downstream side may be difficult to set and the coating liquid may often spread broadly on the downstream side. The wetting expansion of the coating liquid on the downstream side means unevenness of the wetting line, and it has heretofore been known that this may cause a problem of defect formation such as formation of streaks on the coated surface. On the other hand, if the downstream lip land length I_{LO} is longer than 100 μm, then it is impossible to form beads themselves and, as a result, it is impossible to form a thin layer.

The downstream lip land 18b has an overbite shape that is nearer to the web W than the upstream lip land 18a, and therefore the degree of pressure reduction around the lip may be reduced and it is possible to form beads suitable for thin-film formation. The difference between the distance from the downstream lip land 18b to the web W and the distance from the upstream lip land 18a to the web W (this is hereinafter referred to as “overbite length LO”) is preferably from 30 μm to 120 μm, more preferably from 30 μm to 100 μm, even more preferably from 30 μm to 80 μm. When the slot die 13 has such an overbite shape, then the gap G_{L} between the tip lip 17 and the web W is the gap between the downstream lip land 18b and the web W.

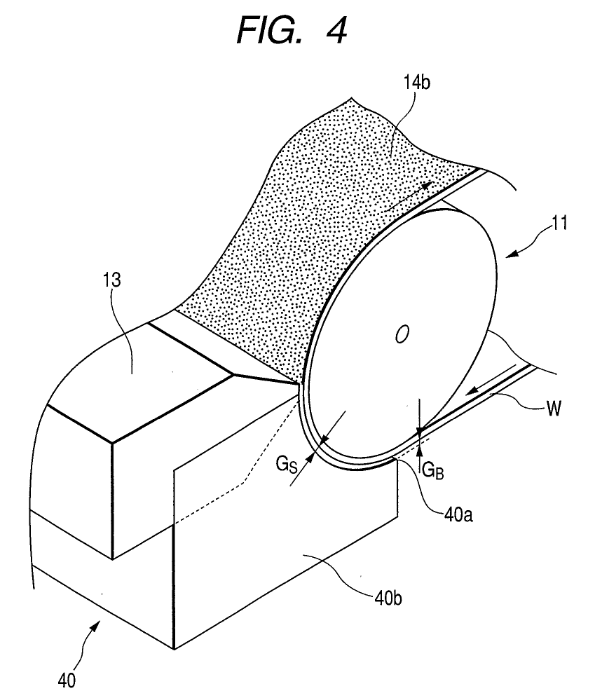

FIG. 4 is a perspective view showing the slot die and around it, used in the coating step in the invention.

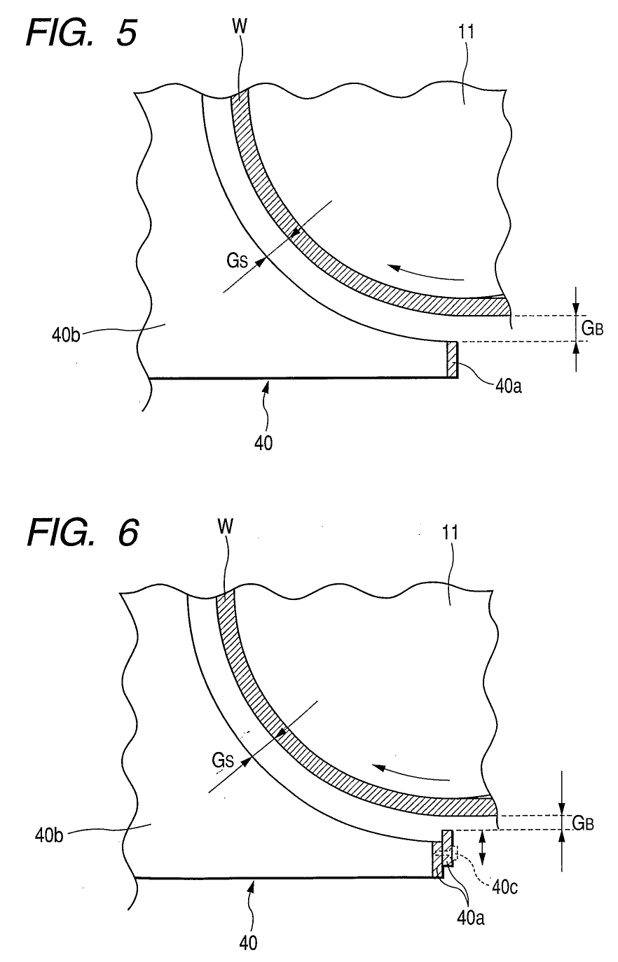

On the side opposite to the running direction side of the web W, disposed is a pressure reduction chamber 40 at the non-contact position in order that sufficient pressure reduction control may be attained for the bead 14a. The pressure reduction chamber 40 comprises a back plate 40a and a side plate 40b for keeping its operation efficiency, and there exist gaps G_{B} and G_{S} between the back plate 40a and the web W and between the side plate 40b and the web W, respectively. FIG. 5 and FIG. 6 each show a cross section of the pressure reduction chamber 40 and the web W that are in adjacent to each other. The side plate and the back plate may be integrated with the chamber body, as in FIG. 5; or they may be so designed that they are fitted to each other via a screw 40c or the like in order that the gap could be varied as in FIG. 6. In any structure, the distance between the back plate 40a and the web W, and the gap actually formed between the side plate 40b and the web W are defined as gaps G_{B} and G_{S}, respectively. The gap G_{B} between the back plate 40a of the pressure reduction chamber 40 and the web W is the distance between the uppermost edge of the back plate 40a and the web W, when the pressure reduction chamber 40 is positioned below the web W and the slot die 13 as in FIG. 4.

Preferably, the pressure reduction chamber is so positioned that the gap G_{B} between the back plate 40a and the web W could be larger than the gap G_{L} between the tip lip 17 of the slot die 13 and the web W. In that condition, the change in the pressure reduction around the beads owing to the eccentricity of the backup roll 11 can be prevented. For example, when the gap G_{L} between the tip lip 17 of the slot die 13 and the web W is from 30 μm to 100 μm, then, the gap G_{B} between the back plate 40a and the web W is preferably from 100 μm to 500 μm.

<Material, Accuracy>

When the length of the tip lip in the web-running direction on the web-running side is larger, then it is unfavorable to bead formation; and when the length varies at any sites in the cross direction of the slot die, then the beads may be unstable owing to some external disturbance. Accordingly, it is desirable that the length fluctuation range in the cross direction of the slot die is controlled to fall within at most 20 μm.

Regarding the material of the tip lip of the slot die, if the tip lip is formed of a material like stainless steel, then it may be deformed during the stage of die working, and, in that condition, even though the length in the web-running direction of the slot die tip lip is controlled to be from 30 to 100 μm as so mentioned hereinabove, the tip lip accuracy could not be satisfactory. Accordingly, for ensuring high working accuracy, it is important that an ultra-hard material such as that described in Japanese Patent No. 2,817,053 is used for it. Concretely, it is desirable that at least the tip lop of the slot die is formed of an ultra-hard alloy with carbide crystals bonding to each other and having a mean particle size of at most 5 μm. The ultra-hard alloy comprises, for example, tungsten carbide (WC) crystal grains bonding to each other with a bonding metal of cobalt, in which the bonding metal may be titanium, tantalum, niobium or their mixture. Preferably, the mean particle size of the WC crystals is at most 3 μm.

For realizing high-accuracy coating in forming the layer, the fluctuation of the gap between the length of the tip lip land on the web-running direction side and the web, in the cross direction of the slot die is also an important factor. It is desirable that a good combination of the two factors, or that is, a straightness within a range capable of suppressing the gap fluctuation in some degree is attained. Preferably, the straightness of the tip lip and the backup roll may be such that the fluctuation range of the gap in the cross direction of the slot die could be at most 5 μm.

<Coating Speed>

When the accuracy of the backup roll and the tip lip as above is attained, then the coating system preferably employed in the invention enables a stable film thickness in a high-speed coating mode. In addition, since the coating system in the invention is a pre-metering system, it readily ensures a stable film thickness even in a high-speed coating mode.

For the coating liquid that is used in a small amount to form the antireflection film as in the invention, the coating system employed in the invention is good since it enables high-speed coating to give a stable film thickness. Any other coating system may also be employed herein, but in a dip coating process, vibration of the coating liquid in a liquid tank is inevitable, and it may cause stepwise coating unevenness. In a reverse roll-coating process, the coating rolls used may be decentered or deflected thereby also causing stepwise coating unevenness. In addition, since these coating methods are post-metering methods, they could hardly ensure a stable film thickness. It is desirable that the coating liquid is applied at a speed of 25 m/min or more according to the production method of the invention, from the viewpoint of the producibility.

<Wet Coating Amount>

In forming a light-scattering layer, it is desirable that the coating liquid for it is applied onto a substrate film directly or via any other layer to give a wet coating film thickness of from 6 to 30 μm, more preferably from 3 to 20 μm for preventing drying unevenness. In forming a low-refractivity layer, it is desirable that the coating liquid for it is applied onto the light-scattering layer directly or via any other layer to give a wet coating film thickness of from 1 to 10 μm, more preferably from 2 to 5 μm.

[Drying]

The web with the light-scattering layer and the low-refractivity layer thus formed on a substrate film directly or via any other layer is then transferred into a heating zone in which the solvent is evaporated away. Preferably, the temperature in the drying zone is from 25° C. to 140° C. Also preferably, the former half of the drying zone is at a relatively low temperature and the latter half thereof is at a relatively high temperature. However, it is desirable that the drying temperature is not higher than a temperature at which the other components than the solvent in the coating composition of each layer may begin to evaporate away. For example, some commercially-available optical radical generators that may be combined with a UV-curable resin may evaporate away to a degree of tens % or so thereof, within a few minutes in hot air at 120° C.; and some monofunctional or difunctional acrylate monomers may begin to evaporate away in hot air at 100° C. In such a case, it is desirable that the drying temperature is not higher than a temperature at which the other components than the solvent in the coating composition of each layer may begin to evaporate away, as so mentioned hereinabove.

Preferably, the dry air speed for drying the coated substrate film is from 01.1 to 2 m/sec when the solid concentration in the coating composition that forms the coating layer is from 1 to 50%, for preventing the drying unevenness.

Also preferably, the temperature difference between the coated substrate film and the conveyor roll that is in contact with the film on the side opposite to the coated side thereof, in the drying zone where the coating layer is dried, is from 0° C. to 20° C., for preventing the drying unevenness owing to the thermal conduction unevenness on the transfer roll.

[Curing]

After the drying zone for solvent evaporation, the web is led through a curing zone where the coating layer is cured through exposure to at least any of ionizing radiations or heat. For example, when the coating layer is a UV-curable one, then it is preferably cured through exposure to UV rays from a UV lamp at from 10 mJ/cm² to 1000 mJ/cm². In this step, the exposure distribution in the cross direction of the web is preferably from 50 to 100% of the maximum exposure, including both edges of the web, more preferably from 80 to 100%. Further, when the curing zone must be purged with nitrogen gas or the like so as to lower the oxygen concentration therein for promoting the surface curing of the web, then the oxygen concentration in the zone is preferably from 0.01% to 5% and the oxygen concentration distribution in the cross direction of the web is preferably at most 2%.

It is desirable that, when the curing degree (100—residual functional group content) of the light-scattering layer has reached a certain value less than 100%, then a low-refractivity layer is formed on the light-scattering layer and the low-refractivity layer is cured through exposure to at least any of ionizing radiations or heat in such a manner that the curing degree of the underlying light-scattering layer could be higher than that before the formation of the low-refractivity layer thereon. In that condition, the adhesiveness between the light-scattering layer and the low-refractivity layer is increased.

The light-scattering film and the antireflection film of the invention produced in the manner as above may be used in fabricating a polarizer, and the polarizer may be used in liquid-crystal display devices. In this case, the polarizer is disposed on the outermost surface of the display panel, by providing an adhesive layer on one side thereof. Preferably, the antireflection film of the invention is used as at least one of the two protective films between which a polarizing film is sandwiched in a polarizer.

Since the antireflection film of the invention serves also as a protective film, the production cost of the polarizer may be reduced. In addition, since the antireflection film of the invention is positioned as the outermost layer of the display panel, external light reflection on the panel may be prevented and the polarizer may have good scratch resistance and good soiling resistance.

When the light-scattering film or the antireflection film of the invention is used as one of two surface-protective films for a polarizing film to construct a polarizer, then the antireflection film is preferably so modified that the surface of the transparent support thereof on the side opposite to the side having the antireflection structure, or that is, the surface of the transparent support that is to be stuck to a polarizing film is hydrophilicated, whereby the adhesiveness of the adhering surface of the film may be improved. The hydrophilication includes saponification, which is described below.

[Saponification]

(1) Method of Dipping in Alkali Solution:

A light-scattering film or an antireflection film is dipped in an alkali solution under a suitable condition, whereby the entire surface of the film reactive with alkali is saponified. Not requiring any specific equipment, this method is favorable in view of its cost. The alkali solution is preferably an aqueous sodium hydroxide solution. Preferably, its concentration is from 0.5 to 3 mol/liter, more preferably from 1 to 2 mol/liter. Also preferably, the temperature of the alkali solution is from 30 to 75° C., more preferably from 40 to 60° C.

The combination of the saponification conditions is preferably a combination of relatively mild conditions, and it may be suitably defined depending on the material and the constitution of the light-scattering film or the antireflection film to be processed and on the intended contact angle of the treated surface.

After dipped in such an alkali solution, it is desirable that the film is well rinsed with water or dipped in a dilute acid to neutralize the alkali component so that no alkali component may remain in the film.

Through the saponification treatment, the surface of the transparent support on the side not having a light-scattering layer or an antireflection layer thereon is thereby hydrophilicated. The protective film for polarizer is stuck to a polarizing film in such a manner that the thus-hydrophilicated surface of the transparent support thereof faces the polarizing film.

The hydrophilicated surface is effective for improving the adhesiveness to an adhesive layer comprising polyvinyl alcohol as the principal ingredient thereof.

The saponification treatment is more desirable when the contact angle to water of the surface of the transparent support on the side opposite to the side thereof to be coated with a light-scattering layer or a low-refractivity layer is smaller, from the viewpoint of the adhesiveness of the support surface to a polarizing film. On the other hand, however, the surface and even the inside of the light-scattering layer-coated or low-refractivity layer-coated support are damaged by alkali in the dipping method, and therefore it is important that the reaction is limited to the necessary minimum condition. For the index of the damage to the constitutive layer to be caused by alkali, the contact angle to water of the transparent support on the side opposite to the layer-coated side thereof may be employed. When the transparent support is formed of a triacetyl cellulose film, then the contact angle is preferably from 10 degrees to 50 degrees, more preferably from 30 degrees to 50 degrees, even mare preferably from 40 degrees to 50 degrees. If the angle is 50 degrees or more, then it is unfavorable since there may occur a problem in the adhesiveness of the support to a polarizing film; but if smaller than 10 degrees, then it is also unfavorable since the damage to the antireflection film may be too large and the physical strength of the support may be lowered.

(2) Method of Applying Alkali Solution to Film:

For evading the damages to the films in the above-mentioned dipping method, preferably employed is a method of applying an alkali solution to the support only con the surface thereof not coated with a light-scattering layer or an antireflection layer, under a suitable condition, then heating it, rinsing it with water and drying it. The application as referred to herein means that the alkali solution or the like processing solution is applied to only the surface to be saponified with it, therefore including not only coating operation but also spraying or contacting with a belt that contains the processing solution. Since this method additionally requires an apparatus and a step of applying an alkali solution to the film, it is inferior to the dipping method (1) in point of its process cost. On the other hand, in this method, since the alkali solution is contacted with only the surface of the film to be sapsonified with it, the method may be applicable even to a film having, on the opposite side thereof, a layer of a material poorly resistant to alkali. For example, a layer formed through vapor deposition or a layer formed through sol-gel reaction may be damaged by an alkali solution, as corroded, dissolved or stripped, and therefore the layer of the type is undesirable for the dipping method. However, since the layer is not brought into contact with an alkali solution in the coating method, there occurs no problem in employing the method for the film coated with the layer of the type.

In any saponification method of above (1) or (2), the rolled support may be unrolled and processed for saponification after the formation of the coating layer thereon, and therefore, the saponification treatment may be carried out as a step of the series of the process of producing the light-scattering film or the antireflection film mentioned above. In addition, the thus-processed film may be laminated with a support that has been unrolled also in one series of the production method. Accordingly, the production method is more efficient in producing polarizers than a method where sheets are processed to fabricate polarizers.

(3) Method of Saponification by Protecting Light-Scattering Layer and Antireflection Layer with Laminate Film:

Like in the above (2), when any one or both of the light-scattering layer and the low-refractivity layer are poorly resistant to alkali, then another method may be employed which is as follows: After the final layer has been formed, a laminate film is stuck to the surface of the film coated with the final layer, and then this is dipped in an alkali solution whereby only the triacetylcellulose surface on the side opposite to the side coated with the final layer could be hydrophilicated, and then the laminate film is peeled away. Also in this method, the necessary hydrophilication for the polarizer-protective film may be attained with no damage to the light-scattering layer and the low-refractivity layer of the film, only on the side of the triacetylcellulose film opposite to the side thereof coated with the final layer. As compared with the method (2), the method (3) gives a waste of the laminate film used therein, but its advantage is that it does not require any specific device for applying an alkali solution to the film to be processed therein.

(4) Method of Dipping in Alkali Solution after Formation of Light-Scattering Layer:

When the light-scattering layer formed is resistant to alkali but the low-refractivity layer to be formed is not resistant to it, then another method may be employable which is as follows: After the light-scattering layer has been formed, the film is dipped in an alkali solution so that both its surfaces are hydrophilicated, and then a low-refractivity layer is formed on the light-scattering layer. Though complicated in some degree, the method is especially favorable when the low-refractivity layer to be formed has a hydrophilic layer, for example, when the layer is a fluorine-containing film layer formed through sol-gel reaction, since the interlayer adhesiveness between the light-scattering layer and the low-refractivity layer of the type is improved by the method.

(5) Method of Forming Light-Scattering Layer or Antireflection Layer on Previously-Saponified Triacetylcellulose Film:

A triacetylcellulose film is previously saponified by dipping in an alkali solution, and then a light-scattering layer and a low-refractivity layer may be formed on any one surface thereof directly or via any other layer. In case where the film is saponified by dipping in an alkali solution, the interlayer adhesiveness between the light-scattering layer or any other layer and the surface of the triacetyl cellulose film hydrophilicated through the saponification may be worsened. In such a case, only the surface of the film to be coated with a light-scattering layer or any other layer may be subjected to corona discharge treatment or glow discharge treatment to thereby remove the hydrophilicated surface from it, and then a light-scattering layer or any other layer may be formed on the thus-treated surface of the film. On the other hand, when the light-scattering layer or any other layer has a hydrophilic group, then the interlayer adhesiveness to the film may be good.

A polarizer that comprises the light-scattering film or the antireflection film of the invention, and a liquid-crystal display device comprising the polarizer are described below.

[Polarizer]

A preferred polarizer of the invention has the light-scattering film or the antireflection film of the invention as at least one of the protective films for the polarizing film (polarizer-protective films) therein. Preferably, the polarizer-protective film is so designed that the contact angle to water on the surface the transparent support thereof opposite to the surface coated with the light-scattering layer or the antireflection layer formed thereon, or that is, on the surface of the support that is to be stuck to a polarizing film, is from 10 degrees to 50 degrees, as so mentioned hereinabove.

Using the light-scattering film or the antireflection film of the invention as a polarizer-protective gives a polarizer having good physical strength, good light-scattering function with good lightfastness, and good antireflection function, and it greatly reduces the production cost and makes it possible to produce thin display devices.

When a polarizer is fabricated, using the light-scattering film or the antireflection film of the invention as one of the polarizer-protective films therein and using an optically-compensatory film having an optically-anisotropic layer mentioned hereinunder as the other of the protective films, and when the thus-fabricated polarizer is used in constructing a liquid-crystal display device, then the image visibility and the contrast of the device in a light room may be improved, and the viewing angle in every direction thereof may be greatly broadened.

[Optically-Compensatory Layer]

Providing an optically-compensatory layer (retardation layer) in a polarizer may improve the viewing angle characteristic of the liquid-crystal display panel having the polarizer therein.

The optically-compensatory layer may be any known one, but for broadening the viewing angle of the display panel comprising the layer, it preferably has a layer with optical anisotropy (optically-anisotropic layer) of a compound having a structural unit of a discotic compound, in which the angle between the disc face of the structure unit of the discotic compound and the transparent support varies relative to the distance from the transparent support.

Preferably, the angle increases with the increase in the distance between the optically-anisotropic layer of the discotic compound and the transparent support.

When the optically-compensatory layer serves as the protective layer for a polarizing film, then it is desirable that the surface of the layer on which it is to be stuck to a polarizing film is saponified, and the saponification for it may be carried out preferably in the same manner as above.

[Polarizing Film]

The polarizing film for use herein may be any known one, or may be cut out from a long polarizing film of which the absorption axis is neither parallel nor vertical to the machine direction of the film. A long polarizing film of which the absorption axis is neither parallel nor vertical to the machine direction thereof may be fabricated according to the method mentioned below.

Briefly, a long polymer film continuously fed out from a production line is, while held at its both edges by holding units, stretched under tension to be a polarizing film. Concretely, the film is stretched at least by 1.1 to 20.0 times in the cross direction of the film in the manner as follows: The running speed difference in the machine direction between the holding units at the edges of the film being stretched is within 3%; and the film-running direction is so curved, with the edges of the film being kept held, that the angle between the film-running direction at the outlet in the step of holding the edges of the film, and the substantially-stretching direction of the film could be from 20 to 70°. In particular, the angle is preferably 45° from the viewpoint of the producibility of the stretched film.

The stretching method for polymer films is described in detail in JP-A 2002-86554, paragraphs [0020] to [0030].

<Liquid-Crystal Display Device>

The light-scattering film and the antireflection film of the invention may be used in image display devices such as liquid-crystal displays (LCD), plasma display panels (PDP), electroluminescent displays (ELD) and cathode-ray tube displays (CRT). Since the antireflection film of the invention has a transparent support, the side of the transparent support of the film may be fitted to the image display panel of an image-display device comprising it.

In case where the light-scattering film or the antireflection film of the invention is used as a surface-protective film on one side of a polarizing film, then it is favorable for transmission-mode, reflection-mode or semitransmission-mode liquid-crystal display devices such as twisted nematic (TN)-mode, super-twisted nematic (STN)-mode, vertical alignment (VA)-mode, in-plain switching (IPS)-mode, or optically-compensatory bent cell (OCB)-mode devices.

The VA-mode liquid-crystal cell includes, in addition to (1) a narrow-sense VA-mode liquid-crystal cell where rod-shaped liquid-crystalline molecules are aligned substantially vertically in the absence of voltage application thereto but are aligned substantially horizontally in the presence of voltage application thereto (as in JP-A 2-176625); (2) a multi-domain VA-mode (MVA-mode) liquid crystal cell for viewing angle enlargement (as in SID97, Digest of Tech. Papers (preprint) 28 (1997), 845), (3) an n-ASM-mode liquid-crystal cell where rod-shaped liquid-crystalline molecules are substantially vertically aligned in the absence of voltage application thereto but are aligned for twisted multi-domain alignment in the presence of voltage application thereto (as in a preprint in the Japan Liquid-Crystal Discussion Meeting, 58-59 (1998), and (4) a survival-mode liquid crystal cell (as announced in LCD International 98).

The OCB-mode liquid-crystal cell is for a liquid-crystal display device in which rod-shaped liquid-crystalline molecules are aligned substantially in the opposite direction (symmetrically), in the upper part and the lower part of the liquid-crystal cell, or that is, the liquid-crystal cell has a bent alignment mode. This is disclosed in U.S. Pat. Nos. 4,583,825 and 5,410,422. In this, the rod-shaped liquid-crystalline molecules are symmetrically aligned in the upper part and the lower part of the liquid-crystal cell, and the bent alignment-mode liquid-crystal cell of the type has a self-optically-compensatory function. Accordingly, the liquid-crystal mode is referred to as an OCB (optically-compensatory bent) liquid-crystal mode. The bent alignment-mode liquid-crystal display device has the advantage of rapid response speed.

In the ECB-mode liquid-crystal cell, rod-shaped liquid-crystalline molecules are substantially horizontally aligned in the absence of voltage application thereto, and the cell mode is most popularly used in color TFT liquid-crystal display devices. This is described in many references, for example, as in “EL, PDP, LCD Displays” issued by Toray Research Center (2001).

In particular, in the TN-mode or IPS-mode liquid-crystal display devices, an optically-compensatory film having a viewing angle-enlarging effect may be used as another one of the two protective films for a polarizing film, than the antireflection film of the invention, as in JP-A 2001-100043. The polarizer having this constitution is especially favorable since it may have both an antireflection effect and a viewing angle-enlarging effect though having a thickness of one polarizer sheet.

### EXAMPLES

The invention is described in more detail with reference to the following Examples, to which, however, the invention is not limited. Unless otherwise specifically indicated, “part” and “%” are all by mass.

(Production of Perfluoro-Olefin Copolymer (1))

Perfluoro-Olefin Copolymer (1)]

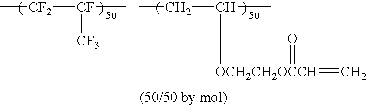

40 ml of ethyl acetate, 14.7 g of hydroxyethyl vinyl ether and 0.55 g of dilauryl peroxide were fed into a 100-ml stainless autoclave equipped with a stirrer, and the system was degassed and purged with nitrogen gas. 25 g of hexafluoropropylene (HFP) was introduced into the autoclave and heated up to 65° C. The pressure when the inner temperature of the autoclave reached 65° C. was 0.53 MPa (5.4 kg/cm²). While the temperature was kept as such, the reaction was continued for 8 hours; and when the pressure reached 0.31 MPa (3.2 kg/cm²), heating the system was stopped and this was left cooled. After the inner temperature lowered to room temperature, the unreacted monomer was expelled away, then the autoclave was opened, and the reaction liquid was taken out. Thus obtained, the reaction liquid was poured into a great excessive amount of hexane, the solvent was removed through decantation, and the precipitated polymer was taken out. The polymer was dissolved in a small amount of ethyl acetate and reprecipitated twice from hexane to thereby completely remove the remaining monomer. After dried, 28 g of the polymer was obtained. Next, 20 g of the polymer was dissolved in 100 ml of N,N-dimethylacetamide, 11.4 g of acrylic acid chloride was dropwise added thereto with cooling with ice, and then this was stirred at room temperature for 10 hours. Ethyl acetate was added to the reaction liquid, washed with water, and the organic layer was extracted out and concentrated. The resulting polymer was reprecipitated from hexane to obtain 19 g of the perfluoro-olefin copolymer (1). The polymer had a refractive index of 1.421.

(Preparation of Sol a)

In a reactor equipped with a stirrer and a reflux condenser, 120 parts of methyl ethyl ketone, 100 parts of acryloyloxypropyltrimethoxysilane (M-5103, produced by Shin-etsu Chemical Industry), and 3 parts of diisopropoxyaluminiumethyl acetacetate were mixed, and 30 parts of ion-exchanged water was added to it and reacted at 60° C. for 4 hours, and then this was cooled to room temperature to obtain a sol (a). Its mass-average molecular weight was 1600. Of those over oligomer components in this, the components having a molecular weight of from 1000 to 20000 accounted for 100%. Its gas chromatography confirmed the absence of the starting compound, acryloyloxypropyltrimethoxysilane, in the sol.

(Preparation of Sol b)

A sol (b) was prepared in the same manner as that for the sol (a), for which, however, 6 parts of acetylacetone was added to the reaction liquid that had been cooled to room temperature.

(Preparation of Coating Liquid a for Light-Scattering Layer)

30 g of a mixture of pentaerythritol triacrylate and pentaerythritol tetraacrylate (PET-30, produced by Nippon Kayaku) was diluted with 36 g of methyl isobutyl ketone and 2.4 g of cyclohexanone. Further, 15 g of a polymerization initiator (Irgacure 184, by Ciba Speciality Chemicals) was added to it, and mixed with stirring. After dissolved, 0.6 g of CAB-531-1 (cellulose acetate butyrate, having a weight-average molecular weight of 260,000 produced by Eastman Chemical) (0.63% by mass of the coating composition) was added to it with stirring, and completely dissolved still with stirring for 5 hours. The resulting solution was applied onto a substrate and cured with UV rays, and the thus-formed coating film had a refractive index of 1.51.

21 g of a 30% dispersion in cyclohexanone of crosslinked polystyrene particles (SX-350, having a refractive index of 1.61 produced by Sohken Chemical) having a mean particle size of 3.5 μm, which had been dispersed with a Polytron disperser at 10000 rpm for 20 minutes, was added to the solution, and finally, 2.3 g of a 2% solution in methyl ethyl ketone of a fluorine-containing surface modifier (FP-149), and 6.2 g of a silane coupling agent (KBM-5103, produced by Shin-etsu Chemical Industry) were added thereto to prepare a complete liquid.

The mixture was filtered through a polypropylene filter having a pore size of 30 μm to prepare a coating liquid (A) for light-scattering layer. Its viscosity at 25° C. was 7 mPa·s.

(Preparation of Coating Liquid B for Light-Scattering Layer)

A coating liquid (B) for light-scattering layer was prepared in the same manner as that for the coating liquid (A) as above, for which, however, 0.6 g of CAB-531-1 (cellulose acetate butyrate, having a weight-average molecular weight of 260,000 produced by Eastman Chemical) was replaced by 1.2 g of methyl polymethacrylate (having a weight-average molecular weight of 120,000 produced by Sigma Aldrich) (1.3% by mass of the coating composition). The cured film of the composition not as yet containing the translucent particles had a refractive index of 1.51, and the viscosity at 25° C. of the complete liquid was 10 mPa·s.

(Preparation of Coating Liquid C for Light-Scattering Layer)

A coating liquid (C) for light-scattering layer was prepared in the same manner as that for the coating liquid (A) as above, to which, however, 0.6 g of CAB-531-1 (cellulose acetate butyrate, having a weight-average molecular weight of 260,000 produced by Eastman Chemical) was not added. The cured film of the composition not as yet containing the translucent particles had a refractive index of 1.51, and the viscosity at 25° C. of the complete liquid was 4 mPa·s.

(Preparation of Coating Liquid A for Low-Refractivity Layer)

15 g of a thermo-crosslinking fluorine-containing polymer having polysiloxane and hydroxyl group and having a refractive index of 1.42 (JN7228A, having a solid concentration of 6% produced by JSR), 0.6 g of a silica sol (a type of silica MKE-ST, having a mean particle size of 15 nm and a solid concentration of 30% produced by Nissan Chemical), 0.8 g of a silica sol (another type of silica MKE-ST, having a mean particle size of 45 nm and a solid concentration of 30% produced by Nissan Chemical), 0.4 g of the sol (a), 3 g of methyl ethyl ketone and 0.6 g of cyclohexanone were stirred, and filtered through a polypropylene filter having a pore size of 1 μm to prepare a coating liquid (A) for low-refractivity layer. The layer formed of the coating liquid had a refractive index of 1.43.

(Preparation of Coating Liquid B for Low-Refractivity Layer)

A coating liquid (B) for low-refractivity layer was prepared in the same manner as that for the coating liquid (A) as above including the amount of the constitutive components therein, for which, however, 1.95 g of a hollow silica sol (having a refractive index of 1.31, a mean particle size of 60 nm and a solid concentration of 20%) was used in place of the silica sol in (A). The layer formed of the coating liquid had a refractive index of 1.38.

(Preparation of Coating Liquid C for Low-Refractivity Layer)

15.2 g of perfluoro-olefin copolymer (1), 1.4 g of a silica sol (a type of silica MEK-ST having a mean particle size of 45 nm and a solid concentration of 30% produced by Nissan Chemical), 0.3 g of a reactive silicone X-22-164B (trade name by Shin-etsu Chemical Industry), 7.3 g of the sol (a), 0.76 g of a photopolymerization initiator (Irgacure 907, trade name by Ciba Speciality Chemicals), 301 g of methyl ethyl ketone, and 9.0 g of cyclohexanone were mixed, and filtered through a polypropylene filter having a pore size of 5 μm to prepare a coating liquid (C) for low-refractivity layer. The layer formed of the coating liquid had a refractive index of 1.44.

(Preparation of Coating Liquid D for Low-Refractivity Layer)

A coating liquid (D) for low-refractivity layer was prepared in the same manner as that for the coating liquid (C) as above including the amount of the constitutive components therein, for which, however, 1.95 g of a hollow silica sol (having a refractive index of 1.31, a mean particle size of 60 nm and a solid concentration of 20%) was used in place of the silica sol in (C). The layer formed of the coating liquid had a refractive index of 1.40.

(Preparation of Coating Liquid E for Low-Refractivity Layer)

A coating liquid (E) for low-refractivity layer was prepared in the same manner as that for the coating liquid (A) as above including the amount of the constitutive components therein, for which, however, a thermo-crosslinking fluorine-containing polymer modified from JN7228A to have a better scratch resistance and have a refractive index of 1.44 (JTA113 having a solid concentration of 6% produced by JSR) was used in place of the thermo-crosslinking fluorine-containing polymer in (A). The layer formed of the coating liquid had a refractive index of 1.45.

### Example 1

### (1) Formation of Light-Scattering Layer

A triacetyl cellulose film (TAC-TD80U, produced by Fuji Photo Film) having a thickness of 80 μm was unwound in a rolled state, and coated with the coating liquid (A) for light-scattering layer by the use of the coating device shown in FIG. 2 according to a die-coating process. The device constitution and the coating condition (basic condition A) are mentioned below. Then, this was dried at 30° C. for 15 seconds and then at 90° C. for 20 seconds, and irradiated with UV rays from a 160 W/cm air-cool metal halide lamp (produced by Eyegraphics) under nitrogen purging. The illuminance was 400 mW/cm² and the irradiation dose was 90 mJ/cm². Thus, the coating layer was cured to be an antiglare light-scattering layer having a thickness of 6 μm, and the thus-coated film was wound up. This is Example 1-1.

In the same manner as above, a light-scattering layer was formed on the support except that the coating liquid (A) was changed to the coating liquid (B) or (C), and the thus-coated film was wound up. The film coated with the coating liquid (B) is Example 1-2; and the film coated with the coating liquid (C) is Comparative Example 1-1.
Basic Condition A: The slot die 13 has an upstream lip land length I_{UP} of 1.0 mm, and a downstream lip land length I_{LO} of 50 μm; the length in the web-running direction of the opening of the slot 16 is 500 μm; and the slot 16 has a length of 50 mm. The gap between the upstream lip land 18a and the web W is longer by 75 μm than the gap between the downstream lip land 18b and the web W (the overbite length is 75 μm); and the gap G_{L} between the downstream lip land 18b and the web W is 100 μm. The gap G_{S} between the side plate 40b of the pressure reduction chamber 40 and the web W, and the gap G_{B} between the back plate 40a and the web W are both 200 μm. The coating speed is 40 m/min; the wet coating amount is 17 ml/m²; the coating width is 1300 mm; and the effective width is 1280 mm.
   (2) Formation of Low-Refractivity Layer:

The triacetyl cellulose film coated with the light-scattering layer formed thereon by applying the coating liquid (A), (B) or (C) to it was again unwound, and the coating liquid (A) for low-refractivity layer was applied to it under the basic condition (B) mentioned below. Then, this was dried at 120° C. for 150 seconds and then at 140° C. for 8 minutes, and irradiated with UV rays from a 240 W/cm air-cool metal halide lamp (produced by Eyegraphics) under nitrogen purging. The illuminance was 400 mW/cm² and the irradiation dose was 900 mJ/cm². Thus, a low-refractivity layer having a thickness of 100 nm was formed on it, and this was wound up.
Basic Condition B: The slot die 13 has an upstream lip land length I_{UP} of 0.5 mm, and a downstream lip land length I_{LO} of 50 μm; the length in the web-running direction of the opening of the slot 16 is 150 μm; and the slot 16 has a length of 50 mm. The gap between the upstream lip land 18a and the web W is longer by 50 μm than the gap between the downstream lip land 18b and the web W (the overbite length is 50 μm); and the gap G_{L} between the downstream lip land 18b and the web W is 50 μm. The gap G_{S} between the side plate 40b of the pressure reduction chamber 40 and the web W, and the gap G_{B} between the back plate 40a and the web W are both 200 μm. The coating speed is 40 m/min; the wet coating amount is 5 ml/m²; the coating width is 1300 mm; and the effective width is 1280 mm.
   (3) Saponification of Antireflection Film:

After formed, the film samples each was treated as follows:

An aqueous solution (1.5 mol/liter) of sodium hydroxide was prepared, and kept at 55° C. An aqueous solution (0.01 mol/liter) of diluted sulfuric acid was prepared and kept at 35° C. The antireflection film formed as above was dipped in the aqueous sodium hydroxide solution for 2 minutes, and then in water to fully wash out the aqueous sodium hydroxide solution. Next, this was dipped in the aqueous diluted sulfuric acid solution for 1 minute and then in water to fully wash out the aqueous diluted sulfuric acid solution. Finally, the sample was well dried at 120° C.

According to the process, a saponified antireflection film was produced. This is Example 1-3, Example 1-4, and Comparative Example 1-2.

(4) Evaluation of Light-Scattering Film:

The films obtained were evaluated in point of the following items. The results are given in Table 1.

(i) Mean Reflectivity:

The back of the film was roughened and then treated with black ink to remove back reflection. In that condition, the spectral reflectivity of the surface of the film was determined, at an incident angle of 5° and within a wavelength range of from 380 to 780 nm, using a spectrophotometer (produced by Nippon Bunkoh). The data indicate the arithmetic average of mirror reflectivity at 450 to 650 nm.

(ii) Light-Scattering Distribution:

The film sample having a width of 1340 mm was cut in the machine direction thereof to give a piece having a length of 500 mm. In a transmission mode, the piece sample was visually analyzed for the light-scattering distribution on its surface in the cross direction, and this was evaluated according to the following criteria:
A: There was little distribution of light scattering, and no unevenness was found in the visual check.
B: The light-scattering distribution was small, and little unevenness was found in the visual check.
C: There was some distribution of light scattering, and unevenness was found in the visual check.
D: The light-scattering distribution was great, and unevenness was found at a glance.

As shown in Table 1 below, other film samples were produced and evaluated in the same manner as in Example 1-3 (antireflection film coated with the coating liquid (A) for light-scattering layer and the coating liquid (A) for low-refractivity layer) and Examaple 1-4 (antireflection film coated with the coating liquid (B) for light-scattering layer and the coating liquid (A) for low-refractivity layer), for which, however, the coating liquid (A) for low-refractivity layer was changed to (B) to (E). These are Example 1-5 to Example 1-12. The test data are given in Table 1.

After the coating liquid for light-scattering layer was continuously fed to the film support, the pocket inside the die coater and the liquid-feeding line (e.g., manifold) were checked for the presence or absence of a precipitation of translucent particles. The results are shown in Table 1.

TABLE 1

| | Light-Scattering | Translucent | Low-Refractivity | Mean | Light-Scattering | |
|---|---|---|---|---|---|---|
| | Layer | Polymer | Layer | Reflectivity (%) | Distribution | Remarks |
| Example 1-1 | A | CAB | none | 4.5 | A | no precipitation |
| Example 1-2 | B | PMMA | none | 4.5 | A | no precipitation |
| Comparative | C | none | none | 4.5 | D | precipitation of translucent |
| Example 1-1 | | | | | | particles |
| Example 1-3 | A | CAB | A | 1.8 | A | no precipitation |
| Example 1-4 | B | PMMA | A | 1.8 | A | no precipitation |
| Comparative | C | none | A | 1.8 | D | precipitation of translucent |
| Example 1-2 | | | | | | particles |
| Example 1-5 | A | CAB | B | 1.4 | A | no precipitation |
| Example 1-6 | A | CAB | C | 2.0 | A | no precipitation |
| Example 1-7 | A | CAB | D | 1.6 | A | no precipitation |
| Example 1-8 | A | CAB | E | 2.0 | A | no precipitation |
| Example 1-9 | B | PMMA | B | 1.4 | A | no precipitation |
| Example 1-10 | B | PMMA | C | 2.0 | A | no precipitation |
| Example 1-11 | B | PMMA | D | 1.6 | A | no precipitation |
| Example 1-12 | B | PMMA | E | 2.0 | A | no precipitation |

CAB: cellulose acetate butyrate
PMMA: polymethyl methacrylate

The results in Table 1 confirm the following:

In the method for producing the light-scattering film of the invention, the coating composition for the light-scattering layer of the film contains a translucent polymer having a molecular weight of at least 1000 in an amount of at least 0.1°% by mass of the composition. Therefore, the method is free from a problem of precipitation of translucent particles in the pocket of a die coater used, which is often troublesome in a die-coating process, and, as a result, the film obtained has the advantage of good light-scattering uniformity in the surface of a broad sample. In addition, the die-coating method of the invention is so designed that it is suitable to a high-speed coating mode in a small wet coating amount of 20 cc/cm², and therefore its producibility is high.

In the coating liquid for low-refractivity layer in Examples 1-1 to 1-12, the organosilane sol (a) was replaced by the sol (b). As a result, the stability in storage of the coating liquid bettered, and its aptitude for continuous coating also bettered.

When 10 g of a mixture of dipentaerythritol pentaacrylate and dipentaerythritol hexaacrylate (DPHA, produced by Nippon Kayaku) was added to the coating liquid (C) and (D) for low-refractivity layer and the resulting coating liquids were applied in the same manner as above. As a result, the scratch resistance of the films produced greatly increased.

### Example 2

A triacetylcellulose film having a thickness of 80 μm (TAC-TD80U, produced by Fuji Photo Film), which had been dipped in an aqueous NaOH solution (1.5 mol/liter) at 55° C. for 2 minutes and then neutralized and washed with water, and any of the light-scattering film produced in Example 1 (Example 1-1, Example 1-2) and the antireflection film (saponified: Example 1-3 to Example 1-12) were stuck to both faces of a polarizing film that had been prepared by stretching an iodine-adsorbed polyvinyl alcohol film, and the film was thus protected to give a polarizer. Using the polarizer, a transmission-type TN-mode liquid-crystal display device was constructed, in which the light-scattering layer or the antireflection layer was the outermost surface layer. Since the device was free from a problem of external light reflection on the display panel thereof, its visibility was good. In particular, the external light reflection on the display panel in the device having the antireflection film was much reduced, and therefore the display contrast increased and the visibility of the device was better.

### Example 3

In the transmission-type TN-mode liquid-crystal cell of Example 2, a viewing angle-enlarging film (Wide View Film SA 12B, produced by Fuji Photo Film) was used as the protective film of the polarizer disposed on the display panel side of the cell and facing the cell, and as the protective film of the polarizer disposed on the backlight side and facing the liquid-crystal cell. Thus constructed, the liquid-crystal display device had an extremely wide viewing angle in every direction thereof, and its visibility was extremely good, and in addition, it displayed high-quality images.

Using an automatically angle-varying photometer, GP-5 Model (produced by Murakami Color Technology Laboratory), the film was disposed vertically to the incident light thereto and analyzed for the scattered light profile in every direction of the film. From the profile, obtained was the scattered light intensity at 30° to a light-going out angle of 0°. In Examples 1-2, 1-4, 1-9 to 1-12 (where the coating liquid (C) for light-scattering layer was used in the samples), the scattered light intensity at 30° to the light-going out angle of 0° was 0.06%. Because of this light-scattering characteristic thereof, the viewing angle of the samples was broadened especially in the downward direction and the yellowing appearance in the right and left direction thereof was reduced. Accordingly, the liquid-crystal display devices constructed herein were extremely good.

For the transmission-type TN-mode liquid-crystal cell in Example 2, used was a high-definition cell of 110 ppi. As a result, the devices of Examples 1-1, 1-3, 1-5 to 1-8 gave high-definition images, having little glare to be caused by uneven enlargement/reduction of pixels owing to the lens effect of the antiglare layer in the polarizer therein.

### Example 4

### Preparation of Sol c

In a 1000 ml volume reaction vessel equipped with a thermometer, a nitrogen-introducing tube and a funnel, 187 g (0.80 mol) of acryloxyoxypropyltrimethoxysilane, 27.2 g (0.20 mol) of methyltrimethoxysilane, 320 g (10 mol) of methanol and 0.06 g (0.001 mol) of KF were charge. Into the mixture, 15.1 g (0.86 mol) of water was slowly added dropwise under stirring at room temperature. After the termination of the dropwise addition, stirring was continued for 3 hr at room temperature. Thereafter, 2 hr stirring under heating was conducted under methanol refluxing. Then, low boiling point fractions were removed under reduced pressure, followed by filtration to obtain 120 g of Sol c. As a result of GPC measurement of the substance thus obtained, it was proved that the sol has a mass average molecular weight of 1500, and that the fraction with molecular weights of from 1000 to 20000 is 30% of the component over oligomer components.

Further, the structure of the resulting substance proved to have the structure represented by the following formula from ¹H-NMR measurements.

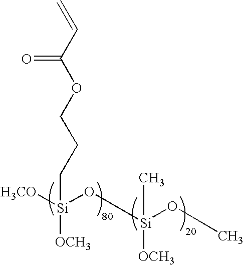

The ratio 80:20 is in molar one.

Furthermore, the condensation ratio α determined by ²⁹Si-NMR measurements was 0.56. From this analytical result, it was confirmed that the major portion of the present silane coupling agent sol consists of linear chain configurations.

In addition, the analysis based on gas chromatography showed a residual ratio of acryloxypropyltrimethoxysilane as the raw material of 5% or less.

(Preparation of Coating Liquid D for Light-Scattering Layer)

A coating liquid D for light-scattering layer was prepared in a similar manner as in the preceding preparation except that the silane coupling agent for the coating liquid B for light-scattering layer (KBM-5103, manufactured by Shin-Etsu Chemical Co., Ltd.) was added in place of the aforementioned Sol c in the same quantity. The viscosity of the coating liquid D for light-scattering layer at 25° C. was 9.5 mPa·s.

(Formation of Antireflection Film)

Anti-reflection films 4-1 (low-refractivity layer A), 4-2 (low-refractivity layer B), 4-3 (low-refractivity layer C), 4-4 (low-refractivity layer D), and 4-5 (low-refractivity layer E) were produced similarly by the production method for the anti-reflection films of Examples 1-4 and 1-9 to 1-12 except that coating fluid B for light-scattering layer was replaced by coating fluid D for light-scattering layer.

(Evaluation Results)

Regarding each of the antireflection films of 4-1 to 4-5, fluctuation in light-scattering property was good represented by A with the same evaluation for the example 1-1.

Moreover, no precipitation of the translucent fine particles was observed in the pocket inside the die-coater as well as the fluid-transporting system (manifold) after continuous 6 hr transport of a coating fluid D for scattering layer.

### Example 5

### Preparation of Coating Fluid E for Light-Scattering Layer

Coating fluid E for light-scattering layer was prepared in the same way as above except that CAB-531-1 (cellulose acetate butyrate with weight average molecular weight of 260,000, manufactured by Eastman Chemical) in coating fluid A for light-scattering layer was replaced to poly(vinyl acetate) (with a weight average molecular weight of 500,000, manufactured by Aldrich). The viscosity of the coating liquid E for light-scattering layer at 25° C. was 9.0 mPa·s.

(Preparation of for Light-Scattering Film)

Light-scattering film 5-1 (without low-refractivity layer) was prepared in the same method as for the light-scattering film of Example 1-2 except that coating fluid B for light-scattering layer was replaced to coating fluid E for light-scattering layer.

(Evaluation Results)

Fluctuation in light-scattering property was evaluated good represented by A.

Regarding the light-scattering of 5-1, fluctuation in light-scattering property was good represented by A with the same evaluation for the example 1-1.

Moreover, no precipitation of the translucent fine particles was observed in the pocket inside the die-coater as well as the fluid-transporting system (manifold) after continuous 6 hr transport of a coating fluid E for scattering layer.

### INDUSTRIAL APPLICABILITY

In the method for producing a light-scattering film of the invention, the coating composition for the light-scattering layer of the film contains a translucent polymer having a molecular weight of 1000 or more, as a transparent resin component thereof, in an amount of 0.1% by mass or more of the composition. In this, therefore, the redispersibility of the translucent particles in the coating composition, after once precipitated therein, is improved, and the coating composition thus having improved redispersibility is applied onto the surface of a transparent support according to a die-coating process having high producibility, and, as a result, a light-scattering film having a uniform in-plane light scatterability and not having a defect of in-plane light-scattering unevenness can be produced at high producibility.

When the light-scattering film of the invention has a low-refractivity layer formed therein, then it may additionally have an antireflection function.

The film may be used as one protective film in a polarizer, and the polarizer may be used in a liquid-crystal display device. The liquid-crystal display device comprising the polarizer is almost free from a glaring problem that may be caused by uneven enlargement/reduction in each pixel owing to the lens effect of the antiglare layer therein.

The entire disclosure of each and every foreign patent application from which the benefit of foreign priority has been claimed in the present application is incorporated herein by reference, as if fully set forth.

1. A method for producing a light-scattering film that comprises a light-scattering layer on a transparent support, comprising:
1) a step of preparing a coating composition for the light-scattering layer, which comprises: translucent particles; a translucent resin that comprises a translucent polymer having a molecular weight of 1000 or more in a ratio of 0.1% by mass or more of the coating composition; and a solvent,
2) a step of running the transparent support which is supported by a backup roll,
3) a step of jetting out the coating composition for the light-scattering layer through a tip of a slot die of an extrusion-type coating machine; and
4) a step of applying the coating composition for the light-scattering layer that has been jetted out through a slot of a tip lip of the slot die, onto the transparent support, while a land of the tip lip is kept adjacent to a surface of a web of the running transparent support.

2. The method for producing a light-scattering film as claimed in claim 1,
wherein the translucent polymer having a molecular weight of 1000 or more in the translucent resin in the coating composition is at least one selected from cellulose derivatives, poly(meth)acrylate derivatives, and poly(vinyl ester)-based polymers.

3. The method for producing a light-scattering film as claimed in claim 1,
wherein a viscosity of the coating composition at 25° C. is controlled to be from 1 to 15 mPa·s.

4. The method for producing a light-scattering film of claim 1,
wherein a mean particle size of the translucent fine particles is from 0.5 to 10 μm, a refractivity difference between the translucent fine particles and the translucent resin is from 0.02 to 0.2, and an amount of the translucent particles in the light-scattering layer is from 3 to 30% by mass of a total solid content of the light-scattering layer.

5. The method for producing a light-scattering film as claimed in claim 1,
wherein the translucent particles are crosslinked polystyrene particles, crosslinked poly(acryl-styrene) particles, crosslinked poly((meth)acrylate) particles or their mixture, the solvent is at least one selected from ketones, toluene, xylene and esters.

6. The method for producing a light-scattering film as claimed in claim 1,
wherein a low-refractivity layer having a lower refractive index than that of the support is formed on the light-scattering layer directly thereon or via any other layer therebetween, and the film has a function as an antireflection film.

7. The method for producing a light-scattering film as claimed in claim 1,
wherein the slot die used for the coating operation is an overbite-shaped slot die that has a land length of from 30 μm to 100 μm at the tip lip thereof on a web-running direction side and is so designed that, when the slot die is set at the coating position, then a distance between the tip lip and the web on the web-running direction side is smaller by from 30 μm to 120 μm than a distance between the tip lip and the web on the side opposite to the web-running direction side.

8. A polarizer comprising:
a polarizing film; and
two protective films stuck to the polarizing film so as to protect both a front face and a back face of the polarizing film,
wherein the light-scattering film produced according to the production method of claim 1 is used as a protective film on one side of the polarizing film.

9. The polarizer as claimed in claim 8,
wherein the other film than the light-scattering film of the two protective films has an optically-compensatory layer that comprises an optically-anisotropic layer, on the side opposite to the side on which it is stuck to the polarizing film,
the optically-anisotropic layer is a layer comprising a compound having a discotic structure unit,
a disc face of the discotic structure unit is inclined relative to a protective film face, and
an angle between the disc face of the discotic structure unit and the protective film face varies in a depth direction of the optically-anisotropic layer.

10. A liquid-crystal display device comprising at least one polarizer of claim 8.
